(19) United States
(12) Patent Application Publication
(10) Pub. No.: US 2022/0383246 A1
(43) Pub. Date: Dec. 1, 2022

(54) METHOD AND SYSTEM FOR HANDLING OBJECT PALLETS IN STORAGE FACILITIES

(71) Applicant: Grey Orange Pte. Ltd., Singapore (SG)

(72) Inventor: Akhilesh Pratap Singh, Shahjahanpur (IN)

(21) Appl. No.: 17/769,789

(22) PCT Filed: Oct. 19, 2020
(86) PCT No.: PCT/IB2020/059808

§ 371 Date: Apr. 18, 2022

(30) Foreign Application Priority Data
Oct. 18, 2019 (GB) 1915096.0

(51) Int. Cl. G06Q 10/08

(52) U.S. Cl. CPC G06Q 10/087

(57) ABSTRACT

A system for handling object pallets in a storage facility is provided. The system includes a plurality of pallet pick-put (PPP) stations, a plurality of movable pallet units (MPUs), a material handling equipment (MHE), and a control server. The control server receives a first request for storing a first object pallet in the storage facility, and selects a first PPP station from the plurality of PPP stations for temporarily placing the first object pallet. The control server identifies a first MPU of the plurality of MPUs for storing the first object pallet, and communicates a placement instruction to an instruction device of the MHE for placing the first object pallet in the first MPU. Based on the placement instruction, the first object pallet is placed in the first MPU by the MHE, when the first MPU reaches a first location of the first PPP station.

### FIELD

The present disclosure relates generally to warehouse management, and, more particularly to a method and a system for handling object pallets in a storage facility.

### BACKGROUND

Typically, in a storage facility, various objects including packed inventory items are received for storage. Such objects are large and heavy and may vary in terms of their size, shape, material, and/or dimensions. Before breaking the objects into individual inventory items for order fulfillment or replenishment, these objects are loaded onto empty pallets and are stored in a bulk storage area of the storage facility. These pallets are capable of handling the heavy weighted objects. Generally, these loaded pallets (i.e., object pallets) are stored in pallet racks.

A first type of pallet rack that is conventionally available in the storage facility includes multiple shelves for storing multiple object pallets. Such a multi-level pallet rack is designed to handle very heavy weights (for example, in a range of 50 to 100 ton (namely, circa 45 tonnes to 90 tonnes) and is typically bolted to the ground so as to prevent toppling during the placement and retrieval of the object pallets. Since the multi-level pallet rack is bolted to the ground, an operator (human or automatic) has to travel to the location of the multi-level pallet rack for placing or retrieving any object pallet. However, these days where storage facilities are implementing a goods-to-person (GTP) environment, such multi-level pallet racks may not be of any use. Thus, most of GTP based storage facilities these days utilize movable pallet units (MPUs) that are transported by using robotic vehicles. Transportation of such MPUs requires a lot of skill for handling and maintaining stability of the MPUs. Thus, in order to reduce a likelihood of accidents (for example, toppling during transportation) during transportation and minimize the damage caused by unprecedented accidents, such MPUs are designed to have only one shelf for storage. Such an approach not only reduces the storage capacity of the storage facility but also increases the cost of storage and reduces the throughput of operations performed at the storage facility.

In light of the foregoing, there exists a need for a technical solution to implement a GTP environment in a storage facility in a more efficient, cost effective, easy to install, time efficient, and secure manner.

### SUMMARY

In an embodiment of the disclosure, a system for handling a plurality of object pallets in a storage facility is provided. The system comprises a plurality of pallet pick-put (PPP) stations having a plurality of pallet platforms, respectively. The system further comprises a plurality of movable pallet units (MPUs) that are located in the storage facility. Each MPU of the plurality of MPUs is a multi-level pallet unit. The system further comprises a material handling equipment (MHE) that is configured to lift the plurality of object pallets from the plurality of pallet platforms for storing in the plurality of MPUs. The system further comprises a control server that is communicatively coupled to the plurality of PPP stations and the MHE. The control server is configured to receive a first request for storing a first object pallet in the storage facility. Based on the first request, the control server selects a first PPP station, having a first pallet platform, from the plurality of PPP stations for temporarily placing the first object pallet. The control server identifies a first MPU of the plurality of MPUs to store the first object pallet that is temporarily placed on the first pallet platform. The control server is further configured to communicate, to an instruction device associated with the MHE, a placement instruction for placing the first object pallet on a first shelf of the first MPU. Based on the placement instruction, the first object pallet is lifted from the first pallet platform and placed on the first shelf of the first MPU by the MHE when the first MPU reaches at a first location of the first PPP station.

In another embodiment of the disclosure, a method for handling a plurality of object pallets in a storage facility is provided. The method includes receiving, by a control server, a first request for storing a first object pallet in the storage facility. Based on the first request, a first PPP station, having a first pallet platform, is selected by the control server from a plurality of PPP stations, for temporarily placing the first object pallet. A first MPU of a plurality of MPUs in the storage facility is identified by the control server for storing the first object pallet that is temporarily placed on the first pallet platform. Each MPU of the plurality of MPUs is a multi-level pallet unit. A placement instruction is communicated by the control server to an instruction device associated with an MHE for placing the first object pallet on a first shelf of the first MPU. The first object pallet is lifted from the first pallet platform and placed on the first shelf of the first MPU by the MHE based on the placement instruction when the first MPU reaches at a first location of the first PPP station.

In another embodiment of the disclosure, a method for handling a plurality of object pallets in a storage facility is provided. The method includes receiving, by a control server, a first request for fulfilling an order. Based on the first request, the control server identifies a first MPU of a plurality of MPUs in the storage facility, such that the identified first MPU stores a first object pallet required for fulfilling the order. Each MPU of the plurality of MPUs is a multi-level pallet unit. A first PPP station, having a first pallet platform, is selected by the control server from a plurality of PPP stations for temporarily placing the first object pallet. A retrieve instruction is communicated by the control server to an instruction device associated with an MHE, for retrieving the first object pallet from a first shelf of the first MPU. The first object pallet is lifted from the first shelf and placed on the first pallet platform by the MHE based on the retrieve instruction when the first MPU reaches at a first location of the first PPP station.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the drawings represent one example of the boundaries. In some examples, one element may be designed as multiple elements, or multiple elements may be designed as one element. In some examples, an element shown as an internal component of one element may be implemented as an external component in another, and vice versa. Various embodiments of the present disclosure are illustrated by way of example, and not limited by the appended drawings, in which like references indicate similar elements:

FIG. 1 is a block diagram that illustrates an exemplary environment, in accordance with an exemplary embodiment of the disclosure;

FIG. 2 is a block diagram that illustrates a movable pallet unit (MPU) storage area of a storage facility of FIG. 1, in accordance with an exemplary embodiment of the disclosure;

FIGS. 3A and 3B are block diagrams that illustrate a material handling equipment (MHE) of FIG. 1, in accordance with an exemplary embodiment of the disclosure;

FIGS. 4A to 4D are block diagrams that collectively illustrate an exemplary scenario for storing an object pallet in an MPU of FIG. 1, in accordance with an exemplary embodiment of the disclosure;

FIG. 5 is a block diagram that illustrates an exemplary scenario for storing an object pallet in an MPU, in accordance with another exemplary embodiment of the disclosure;

FIGS. 6A to 6D are block diagrams that collectively illustrate an exemplary scenario for retrieving an object pallet from an MPU of FIG. 1, in accordance with an exemplary embodiment of the disclosure;

FIG. 7 is a block diagram that illustrates a control server of FIG. 1, in accordance with an exemplary embodiment of the disclosure;

FIG. 8 is a block diagram that illustrates system architecture of a computer system, in accordance with an exemplary embodiment of the disclosure;

FIGS. 9A to 9C, collectively represent a flow chart that illustrates a process (e.g., method) for storing object pallets in an MPU, in accordance with an exemplary embodiment of the disclosure; and

FIG. 10 represents a flow chart that illustrates a process (e.g., method) for retrieving object pallets from MPUs, in accordance with an exemplary embodiment of the disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the disclosure provide a method and a system for handling object pallets in a storage facility. The system includes a plurality of pallet pick-put (PPP) stations having a plurality of pallet platforms, respectively. The system further includes a plurality of movable pallet units (MPUs) that are located in the storage facility. Each MPU of the plurality of MPUs is a multi-level pallet unit having a dynamically adjustable structure. The system further includes a material handling equipment (MHE) that is configured to lift the plurality of object pallets from the plurality of pallet platforms for storing in the plurality of MPUs. The system further includes a control server that is communicatively coupled to the plurality of PPP stations and the MHE.

In a goods-to-person (GTP) implementation, the control server is configured to receive a first request for storing a first object pallet in the storage facility. The first request includes details pertaining to a unique identifier assigned to the first object pallet. Based on the first request, the control server selects a first PPP station, having a first pallet platform, from the plurality of PPP stations for temporarily placing the first object pallet. The control server selects the first PPP station based on at least one of an availability of the first PPP station, a capacity of the first pallet platform, or a throughput of the first PPP station. The control server identifies a first MPU of the plurality of MPUs to store the first object pallet that is temporarily placed on the first pallet platform. The control server identifies the first MPU based on at least one of an availability of the first MPU, a distance between the first MPU and the first location of the first PPP station, a weight of the first object pallet, or a weight handling capacity of the first MPU. The control server further selects a first transport vehicle from a plurality of transport vehicles in the storage facility for transporting the identified first MPU from a current location of the first MPU to a first location of the first PPP station. The control server selects the first transport vehicle based on availability of the first transport vehicle, distance between current location of the first transport vehicle and the current location of the first MPU, the weight of the first MPU, or the load handling capacity of the first transport vehicle. The control server communicates to an instruction device associated with the MHE, a placement instruction for placing the first object pallet on a first shelf of the first MPU. Based on the placement instruction, the first object pallet is lifted from the first pallet platform and placed on the first shelf of the first MPU by the MHE when the first MPU reaches at the first location of the first PPP station. Likewise, the control server may further utilize the plurality of pallet pick-put (PPP) stations, the plurality of MPUs having the plurality of object pallets stored therein, the MHE, and the plurality of transport vehicles for retrieving one or more of the stored object pallets from the plurality of MPUs for order fulfillment or inventory replenishment.

Thus, the method and system facilitate a cost effective and efficient way for implementing the GTP environment in the storage facility. Technological improvements in the transport vehicles, the MHE, and the control server lead to a secure and time efficient system.

In some embodiments, an “object pallet” is a combination of a pallet and an object that is loaded on the pallet. The object may be a collection of various inventory items packed together or a single inventory item that is large and heavy. The objects are loaded on empty pallets and are referred to as the object pallets. The object pallets are large in size and heavy in weight. For example, the weight of an object pallet may be in the range of 1 to 1.5 ton (namely, circa 0.9 tonnes to 1.4 tonnes).

In some embodiments, a “pallet pick-put (PPP) station” is an operating station for handling various pallet pick-put operations in a storage facility. For example, an object pallet is temporarily placed on a pallet platform of the PPP station before being stored in a storage unit.

In some embodiments, a “movable pallet unit (MPU)” is a multi-level pallet storage rack that is capable of storing multiple heavy object pallets. The MPU has a dynamic structure and adjustable shelves to accommodate the object pallets of any size, shape, or dimensions. In a GTP implementation, the MPU is automatically transported by a transport vehicle to a location of pallet pick-put station, where various pallet pick-put operations are performed on the MPU.

In some embodiments, a “material handling equipment (MHE)” is a system or an apparatus that is used for lifting heavy object pallets. The MHE may be a fully-automatic system, a semi-automatic system, or a manually operated system. Examples of the MHE may include a forklift, a gantry, an operator machine, a pallet jack, or any mechanical machine that is capable of lifting heavy object pallets and transiting in the storage facility.

In some embodiments, a “transport vehicle” is a robotic vehicle that executes one or more operations at a storage facility based on instructions received from a control server. For example, the transport vehicle may transport MPUs in the storage facility from a source location to a destination location for placement or retrieval of object pallets from the MPU.

In some embodiments, a “first request” is a request received by a control server from an external or internal communication system. In one example, the first request may be for storing object pallets in MPUs. In another example, the first request may be for retrieving object pallets from the MPUs for order fulfillment or inventory replenishment. The first request may include information pertaining to the object pallets that are to be stored in the MPUs or retrieved from the MPUs.

In some embodiments, a “control server” is a physical or cloud data processing system on which a server program runs. The control server may be implemented in hardware or software, or a combination thereof. In one embodiment, the control server may be implemented in computer programs executing on programmable computers, such as personal computers, laptops, or a network of computer systems. The control server is responsible for handling object pallets in a GTP implementation.

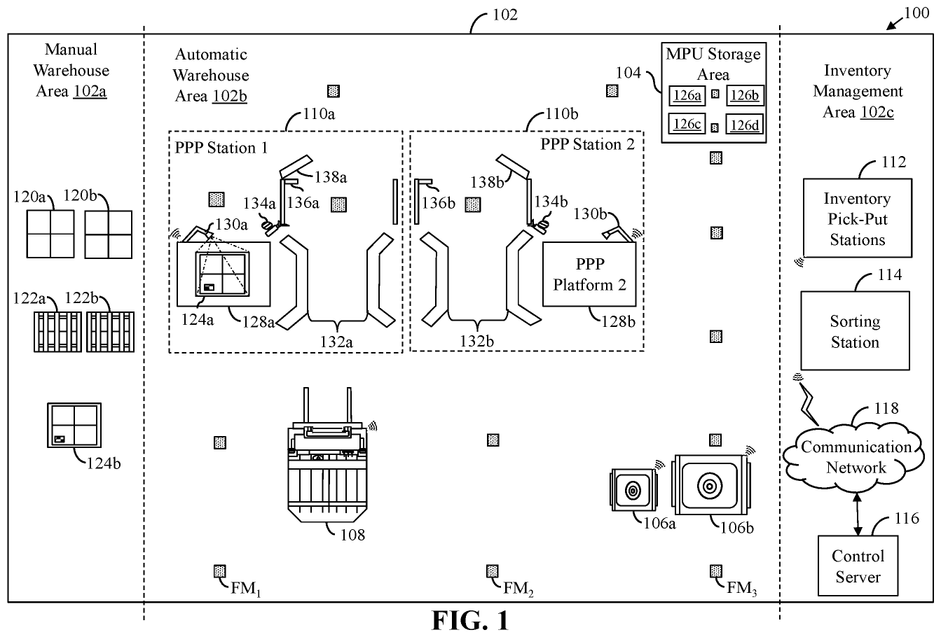

FIG. 1 is a block diagram that illustrates an exemplary environment 100, in accordance with an exemplary embodiment of the disclosure. The environment 100 includes a storage facility 102. The storage facility 102 may be segregated into various sections. For example, as shown in FIG. 1, the storage facility 102 is segregated into three sections, i.e., a manual warehouse area 102a, an automatic warehouse area 102b, and an inventory management area 102c. The automatic warehouse area 102b may include a movable pallet unit (MPU) storage area 104, transport vehicles 106 (for example, first and second transport vehicles 106a and 106b), a material handling equipment (MHE) 108, and pallet pick-put (PPP) stations 110 (for example, first and second PPP stations 110a and 110b). The inventory management area 102c may include inventory pick-put stations 112 and a sorting station 114. The environment 100 further includes a control server 116. The transport vehicles 106, the MHE 108, the PPP stations 110, the inventory pick-put stations 112, the sorting station 114, and the control server 116 may communicate with each other via a communication network 118 established therebetween.

The manual warehouse area 102a may receive various objects 120 (for example, first and second objects 120a and 120b) for storing in the automatic warehouse area 102b. Each object 120 may be a collection of various inventory items packed together or a single inventory item that is large and heavy, for example, having a weight in a range of 1 to 1.5 ton (namely, circa 0.9 tonnes to 1.4 tonnes). In one example, each object 120 may include various inventory items that are packed together based on orders. In another example, each object 120 may include inventory items that are packed together based on material, shape, or size of the inventory items. The objects 120 may be loaded on to empty pallets 122 (for example, first and second empty pallets 122a and 122b) in the manual warehouse area 102a before storing in the automatic warehouse area 102b. For example, an object may be loaded on to an empty pallet and a combination of the pallet and the object, which is loaded on the pallet, is referred to as an “object pallet”. For the sake of brevity, two object pallets 124a and 124b are shown in FIG. 1. Load handling capacity of the empty pallets 122 varies based on dimensions of the empty pallets 122. For example, the dimensions of the first empty pallet 122a may be 1×1 square units and the dimensions of the second empty pallet 122b may be 2×2 square units. In such a scenario, the load handling capacity of the second empty pallet 122b may be four times the load handling capacity of the first empty pallet 122a. An empty pallet may be selected for loading an object based on the dimensions and the load handling capacity of the empty pallet and the weight, size, and dimensions of the object. The loading of the objects 120 on to the empty pallets 122 may be performed by various operators in the manual warehouse area 102a.

The object pallets 124a and 124b are assigned unique identifiers for reference. Examples of the unique identifiers may include local plate numbers (LPNs), bar codes, quick response (QR) codes, radio frequency identifier (RFID) tags, or the like. The details of the assigned unique identifiers are then communicated to the control server 116. The object pallets 124a and 124b may be then transferred to the automatic warehouse area 102b for storing. For example, as shown in FIG. 1, the object pallet 124a is transferred to the automatic warehouse area 102b for storing.

The automatic warehouse area 102b is that section of the storage facility 102 where multiple automated operations are performed for storing the transferred object pallets, for example, the object pallet 124a. The automated operations may be performed by utilizing the MPU storage area 104, the transport vehicles 106, the MHE 108, and/or the PPP stations 110.

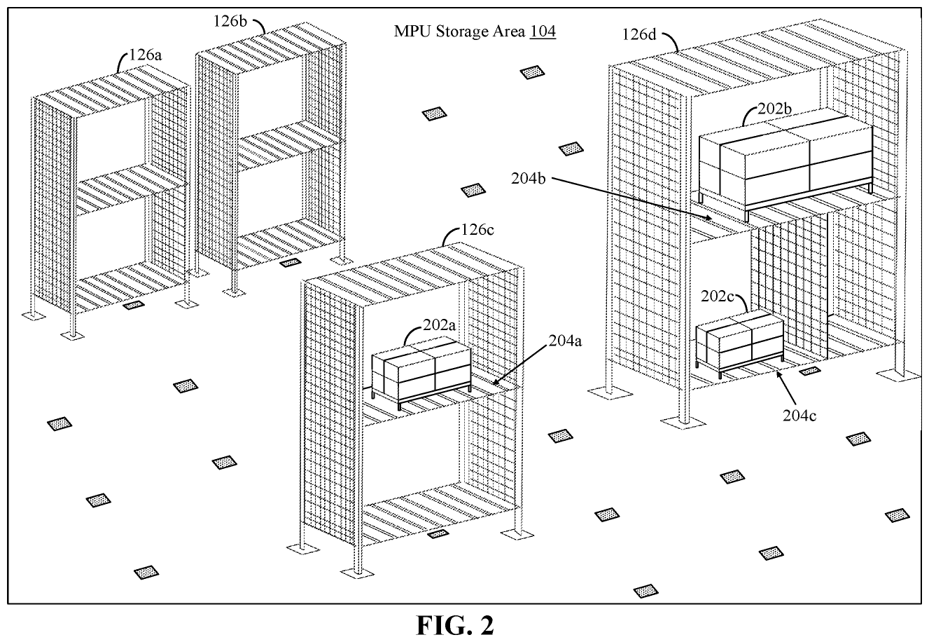

The MPU storage area 104 is a place where various MPUs 126 (for example, first through to fourth MPUs, 126a to 126d) are stationed for storing the object pallets, for example, the object pallets 124a and 124b. The MPU storage area 104 may be of any size and shape, for example, a rectangular shape. The MPUs 126 are multi-leveled structures that accommodate multiple object pallets for storing. The structure of each MPU 126 defines the load handling capacity of the corresponding MPU 126. For example, the first MPU 126a may be a three-level structure and may be capable of handling in a range of 5 to 6 ton of weight (namely, circa 4.5 tonnes to 5.3 tonnes), whereas the second MPU 126b may be a two-level structure that is capable of handling in a range of 3 to 4 ton of weight (namely, circa 2.7 tonnes to 3.6 tonnes). The structure of the MPUs 126 is explained in detail in conjunction with FIG. 2.

The transport vehicles 106 may include suitable logic, instructions, circuitry, interfaces, and/or code, executable by the circuitry, to execute various operations for transporting the MPUs 126 within the automatic warehouse area 102b, for example, from the MPU storage area 104 to the PPP stations 110 or from the PPP stations 110 to the MPU storage area 104. The transport vehicles 106 may be configured to transport the MPUs 126 based on the instructions received from the control server 116. Each transport vehicle 106 may have a different load handling capacity. For example, the first transport vehicle 106a may be capable of handling 1.5 ton of weight whereas the second transport vehicle 106b may be capable of handling only 1 ton of weight. In one exemplary scenario, two or more transport vehicles 106 may be configured to operate in-sync to transport a single MPU when the weight of the single MPU surpasses the load handling capacity of each of the transport vehicles 106.

In one embodiment, each transport vehicle 106 may include a lifting mechanism for lifting the MPUs 126 and a movement mechanism for traversing different paths in the automatic warehouse area 102b. The lifting mechanism and the movement mechanism in each transport vehicle 106 may be powered by respective first and second sets of motors. The first and second sets of motors may supply appropriate current to the lifting mechanism and the movement mechanism, respectively, for functioning. The amount of current supplied by the first and second sets of motors to the lifting mechanism and the movement mechanism, respectively, may be dependent on a weight of an MPU that is to be lifted and transported by the corresponding transport vehicle 106. Each transport vehicle 106 may further include first and second sets of weighers attached to the lifting mechanism and the movement mechanism, respectively. In one example, the first and second sets of weighers are current sensors that are configured to measure the amount of current supplied to the lifting mechanism and the movement mechanism, respectively. The second set of motors may not supply any current to the movement mechanism when the corresponding transport vehicle 106 is at rest. Thus, the second set of weighers may measure the amount of current supplied to the movement mechanism only when the corresponding transport vehicle 106 is in motion. Information pertaining to the amounts of current measured by the first and second sets of weighers may be utilized to determine a weight distribution profile of the MPU carried by the corresponding transport vehicle 106.

Examples of the transport vehicles 106 may include, but are not limited to, automated guided vehicles, transportation robots, robotic vehicles, automated transport trolleys, or the like. The transport vehicles 106 may communicate with the control server 116 via the communication network 118 by using various wired, wireless, or optical communication protocols.

In one embodiment, the storage facility 102 may include fiducial markers (e.g., barcodes, QR codes, or the like) to facilitate navigation for the transport vehicles 106 and the M HE 108 in the storage facility 102. The storage facility 102 may be marked with various fiducial markers (such as fiducial markers FM₁, FM₂, and FM₃). For the sake of brevity, only the fiducial markers FM₁, FM₂, and FM₃ have been labeled. It will be apparent to those of skill in the art that the entire storage facility 102 may include the fiducial markers without deviating from the scope of the disclosure. In another embodiment, the storage facility 102 may not include any fiducial markers. In such a scenario, the transport vehicles 106 and the MHE 108 may move within the storage facility 102 by using localization-based navigation techniques and/or global positioning system (GPS)-based navigation techniques.

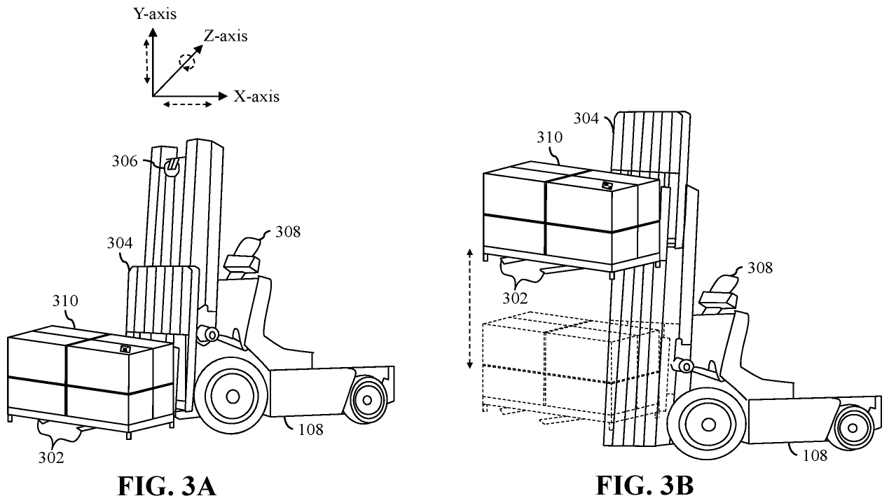

The MHE 108 may include suitable logic, instructions, circuitry, interfaces, and/or code, executable by the circuitry, to execute various operations for placing the object pallets 124a and 124b in the MPUs 126. The MHE 108 may be further configured to execute various operations for retrieving other object pallets that are already stored in the MPUs 126. The MHE 108 may execute the operations based on instructions received from the control server 116. The MHE 108 may be a fully-automatic system, a semi-automatic system, or a manually operated system. Examples of the MHE 108 may include, but are not limited to, a forklift, a gantry, an operator machine, a pallet jack, or the like. The operation of the MHE 108 is explained in detail in conjunction with FIGS. 3A and 3B.

The PPP stations 110 may include suitable logic, instructions, circuitry, interfaces, and/or code, executable by the circuitry, to execute various operations for facilitating the storage of the object pallets 124a and 124b in the automatic warehouse area 102b. The first PPP station 110a may include a first pallet platform 128a, a first scanner 130a, a first alignment unit 132a, a first tower light 134a, a first clamping unit 136a, and a first mirror 138a. Likewise, the second PPP station 110b may include a second pallet platform 128b, a second scanner 130b, a second alignment unit 132b, a second tower light 134b, a second clamping unit 136b, and a second mirror 138b. In one example, the first pallet platform 128a may be a stationary platform. In another example, the first pallet platform 128a may be a movable platform, for example, a conveyor belt. The first and second PPP stations 110a and 110b are located at first and second locations within the automatic warehouse area 102b and are functionally similar to each other. The first and second PPP stations 110a and 110b may further include other suitable components or systems, in addition to the components or systems which are illustrated herein to describe and explain the function and operation of the present disclosure. For the sake of brevity, the automatic warehouse area 102b is shown to include two PPP stations. However, in actual implementation the automatic warehouse area 102b may include any number of PPP stations without deviating from the scope of the disclosure.

When the object pallet 124a is transferred to the automatic warehouse area 102b from the manual warehouse area 102a, one of the first and second PPP stations 110a and 110b is selected to carry out the operations required for storing the object pallet 124a. In one exemplary scenario, the first PPP station 110a may be selected. In such a scenario, the object pallet 124a is temporarily placed on the first pallet platform 128a of the selected first PPP station 110a as shown in FIG. 1. The first scanner 130a may be configured to scan the object pallet 124a that is placed on the first pallet platform 128a and communicate a first set of signals to the control server 116 based on the scanning. Based on the first set of signals, the control server 116 may be configured to determine a first set of parameters of the object pallet 124a. The first set of parameters may include a weight of the object pallet 124a, dimensions of the object pallet 124a, a shape of the object pallet 124a, a size of the object pallet 124a, a type of the object pallet 124a, or the like. When one of the MPUs 126 (for example, the first MPU 126a) reaches a first location of the first PPP station 110a, the MHE 108 lifts the object pallet 124a from the first pallet platform 128a for placing in the first MPU 126a that has reached the first location. The first alignment unit 132a may be configured to determine whether the orientation of the MHE 108 or the object pallet 124a lifted by the MHE 108 is aligned with respect to the first MPU 126a. When the object pallet 124a is determined to be misaligned, the first alignment unit 132a may align the orientation of the object pallet 124a with respect to the first MPU 126a. When the MHE 108 is determined to be misaligned, the first alignment unit 132a may align the orientation of the MHE 108 with respect to the first MPU 126a.

The first tower light 134a may be utilized to indicate if there is any error or fault in the operations performed for the storage of the object pallets 124. The first tower light 134a may be configured to glow in green color to indicate that there is no error in the operations and the first tower light 134a may be further configured to glow in red color if there is any error or fault in the operations. For example, if there is any obstacle in the path to be followed by the MHE 108, the first tower light 134a may glow in red color. In one embodiment, different colors of the first tower light 134a may be dedicated to different types of system errors and faults. The first clamping unit 136a is used to hold and provide support to the first MPU 126a that has reached the first location while the object pallet 124a is being placed in the first MPU 126a by the MHE 108, thereby preventing the first MPU 126a from toppling. In one example, the first tower light 134a may glow in red color when the first clamping unit 136a is unable to clamp the first MPU 126a after the first MPU 126a has reached the first location of the first PPP station 110a. The first mirror 138a may be utilized to determine whether the object pallet 124a is properly placed in the first MPU 126a by the MHE 108.

The control server 116 may include suitable logic, circuitry, interfaces, and/or code, executed by the circuitry, for managing various operations performed in the storage facility 102. The operations performed by the control server 116 may enable the control server 116 to implement GTP scenario in the automatic warehouse area 102b and the inventory management area 102c. The control server 116 may be configured to receive various requests for performing operations in the storage facility 102. In one embodiment, the control server 116 may receive a request for storing the object pallets 124a and 124b in the storage facility 102. In another embodiment, the control server 116 may receive a request for fulfilling an order from the storage facility 102.

In an exemplary scenario where the control server 116 receives the request for storing the object pallets 124a and 124b in the storage facility 102, the control server 116 may receive the unique identifiers that are assigned to the object pallets 124a and 124b. The control server 116 may be configured to select one of the PPP stations 110 (for example, the first PPP station 110a) for temporarily placing the object pallet 124a that is transferred to the automatic warehouse area 102b from the manual warehouse area 102a.

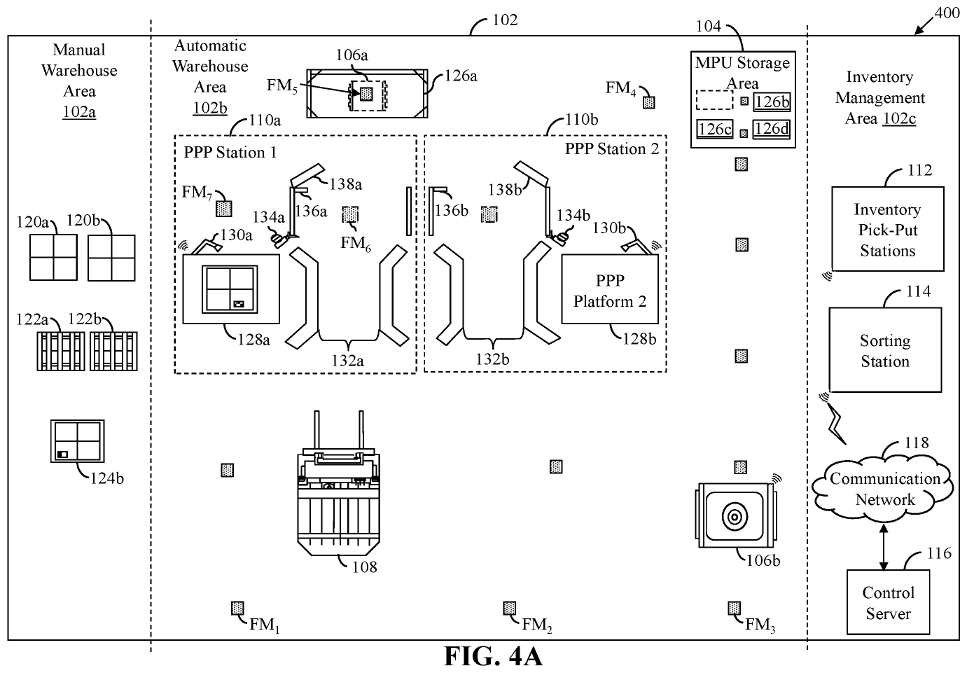

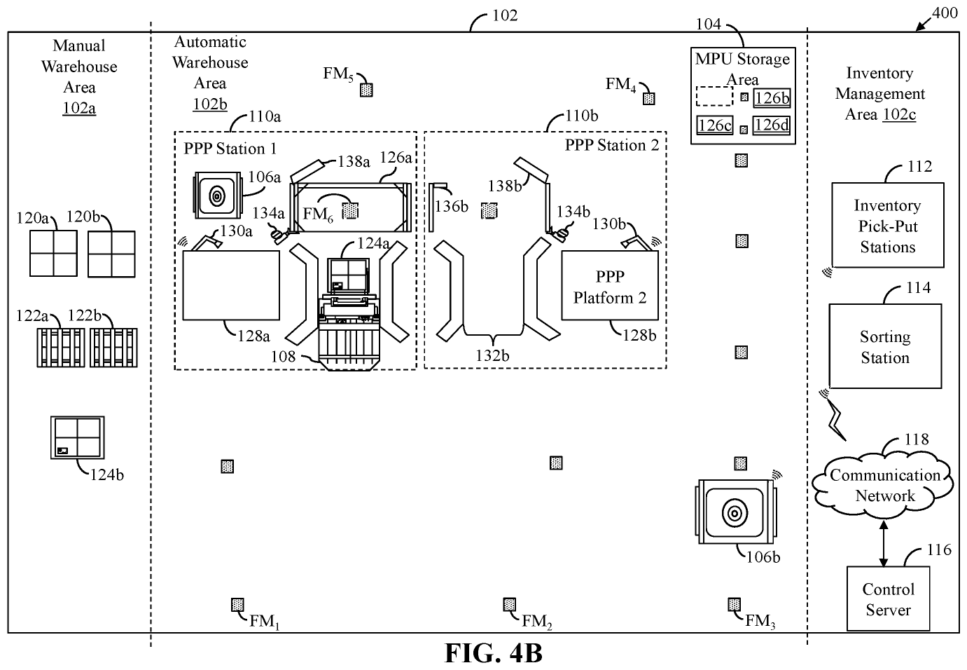

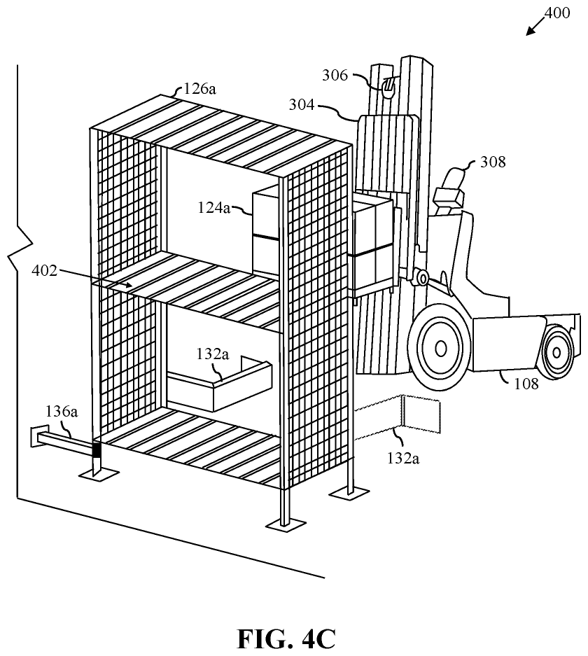

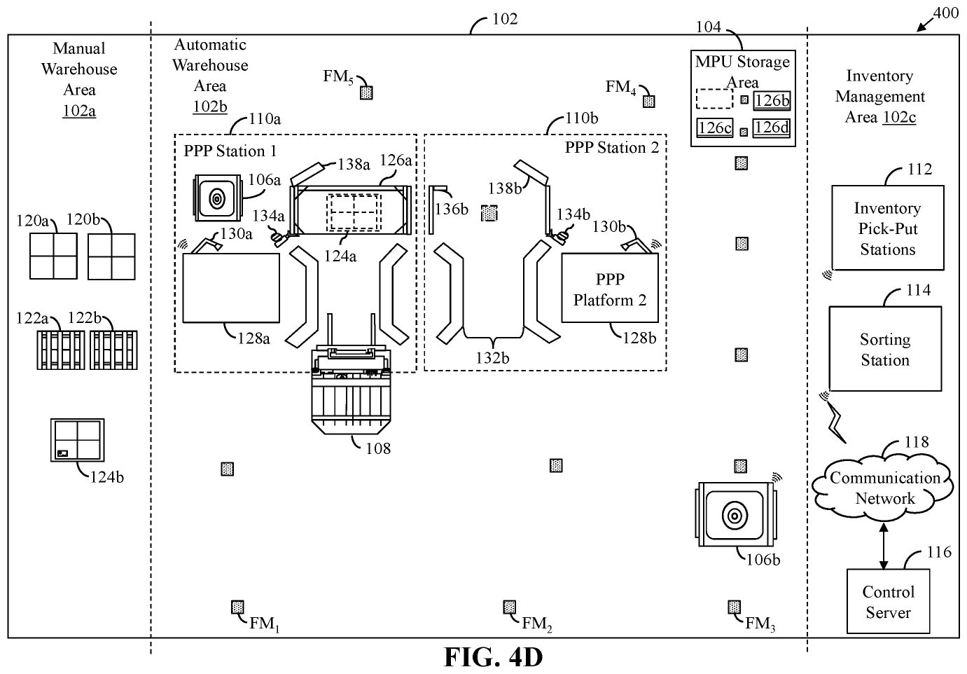

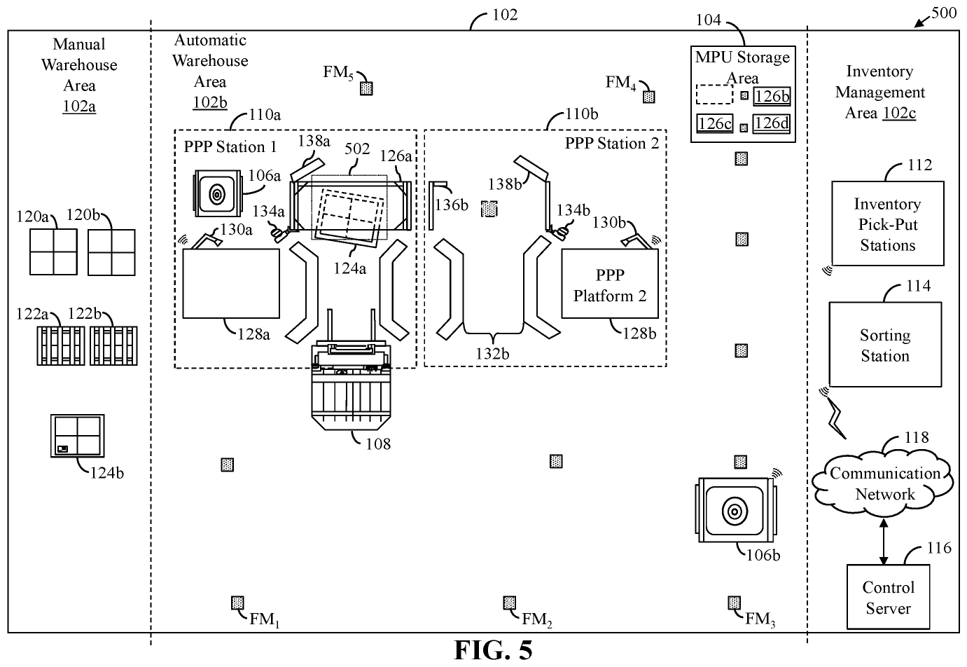

The control server 116 may be further configured to identify one of the MPUs 126 (for example, the first MPU 126a) for storing the object pallet 124a. The control server 116 may be further configured to select a first shelf from various shelves of the first MPU 126a for storing the object pallet 124a. The control server 116 may further determine whether placing the object pallet 124a on the first shelf maintains a center of gravity (COG) of the first MPU 126a within a COG tolerance region of the first MPU 126a. The COG of the first MPU 126a is a point at which the weight of the first MPU 126a may act. The COG tolerance region is an acceptable range defined for the COG of the first MPU 126a such that when the COG lies within the COG tolerance region, the first MPU 126a is stable and may not topple when moved. The COG tolerance region may be of any shape or size, for example, triangular, spherical, cuboid, or the like. The control server 116 may be further configured to determine one or more features associated with the first MPU 126a for achieving a correct placement of the object pallet 124a on the first shelf. The determined features may include, but not limited to, edges of the selected first shelf, a three-dimensional (3D) envelope, and/or an allowable overhang threshold. The control server 116 may determine the features based on the dimensions, size, weight, and shape of the object pallet 124a and the dimensions and size of the selected first shelf. The features determined by the control server 116 are described in detail in FIGS. 4A and 5. The control server 116 may be further configured to select one of the transport vehicles 106, for example, the first transport vehicle 106a. Based on the selection of the first transport vehicle 106a, the control server 116 may be configured to communicate a move instruction to the first transport vehicle 106a for instructing the first transport vehicle 106a to transport the first MPU 126a from the MPU storage area 104 to the first location of the first PPP station 110a.

The control server 116 may communicate a placement instruction to the MHE 108 for lifting the object pallet 124a from the first pallet platform 128a and placing the object pallet 124a on the first shelf of the first MPU 126a. The control server 116 further receives a notification from the MHE 108 indicating that the object pallet 124a is stored on the first shelf of the first MPU 126a. The control server 116 may be further configured to receive a second set of signals from the first transport vehicle 106a, the MHE 108, the first PPP station 110a, or the first MPU 126a. Based on the second set of signals received, the control server 116 may be configured to determine whether the COG of the first MPU 126a is within the COG tolerance region of the first MPU 126a or the object pallet 124a that is stored on the first shelf is in alignment with respect to the features determined by the control server 116. If the control server 116 determines that the COG of the first MPU 126a is out of the COG tolerance region or the object pallet 124a is misaligned with respect to the determined features (for example, the edges of the first shelf or the 3D envelope of the first MPU 126a), the control server 116 may communicate a rearrangement instruction indicating to correct the alignment of the object pallet 124a.

In another exemplary scenario where the control server 116 receives a request for order fulfillment, the control server 116 may be configured to identify an MPU (e.g., the first MPU 126a) that stores an object pallet required for fulfilling the order. The control server 116 may further select a PPP station (e.g., the first PPP station 110a) for temporarily placing the required object pallet. The control server 116 may select a transport vehicle (e.g., the first transport vehicle 106a) for transporting the first MPU 126a to the first location of the first PPP station 110a. The control server 116 may communicate the move instruction to the first transport vehicle 106a for transporting the first MPU 126a from the MPU storage area 104 to the first location. The control server 116 may further communicate a retrieve instruction to the MHE 108 for retrieving the required object pallet from the first MPU 126a and placing the retrieved object pallet on the first pallet platform 128a.

The inventory management area 102c is a section in the storage facility 102 where various goods-to-person operations (for example, order fulfillment, stock fulfillment, sorting, object pallet splitting, or the like) are performed for inventory management. In one embodiment, the inventory pick-put stations 112 may receive the object pallets stored in the MPUs 126 from the automatic warehouse area 102b for fulfilling various orders. Based on the order requests, the inventory pick-put stations 112 may break the stored object pallets into inventory items and fulfill the order request accordingly. In another embodiment, the inventory pick-put stations 112 may receive various inventory items for replenishment or order fulfillment. The sorting station 114 may be configured to sort the inventory items or the object pallets into various categories, for example, based on size, shape, material, shipping destination, or the like. The operations in the inventory management area 102c may be performed by human operators, automatic operators in the storage facility 102, or a combination thereof.

The communication network 118 is a medium through which content and messages are transmitted between the transport vehicles 106, the MHE 108, the PPP stations 110, the inventory pick-put stations 112, the sorting station 114, and the control server 116. Examples of the communication network 118 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the exemplary environment 100 may connect to the communication network 118 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a block diagram that illustrates the MPU storage area 104 of the storage facility 102 of FIG. 1, in accordance with an exemplary embodiment of the disclosure. The MPU storage area 104 includes the MPUs 126. In one embodiment, the MPUs 126 may be uniformly spaced in the MPU storage area 104. In another embodiment the MPUs 126 may be non-uniformly spaced in the MPU storage area 104. In one embodiment, the MPU storage area 104 may be marked with various fiducial markers to facilitate transportation of the MPUs 126 by the transport vehicles 106. The fiducial markers may correspond to location markers that are located at pre-determined locations and may be associated with the positions of the MPUs 126. The pre-determined locations do not need to conform to any specific pattern, and may be subject to a configuration of the MPU storage area 104. In one exemplary scenario, the placement of the fiducial markers may be uniform (i.e., a distance between consecutive fiducial markers is constant). In another exemplary scenario, the placement of the fiducial markers may be non-uniform (i.e., a distance between consecutive fiducial markers is variable). In another embodiment, the MPU storage area 104 may not be marked with any fiducial markers. In such a scenario, the locations of the MPUs 126 may be indicated by localization-based coordinates and/or GPS-based coordinates.

The structure and material of the MPUs 126 are designed for handling heavy weights of object pallets, for example, object pallets 202a, 202b, and 202c and the object pallets 124a and 124b shown in FIG. 1. The MPUs 126 are multi-leveled pallet storage units having dynamically adjustable shelves. The third MPU 126c is shown to store the object pallet 202a on a first shelf 204a and the fourth MPU 126d is shown to store the object pallets 202b and 202c. The object pallet 202b is stored on a second shelf 204b of the fourth MPU 126d and the object pallet 202c is stored on a third shelf 204c of the fourth MPU 126d. Since the dimensions of the object pallet 202c are smaller as compared to the dimensions of the third shelf 204c, the third shelf 204c may be partitioned (as shown in FIG. 2) to accommodate another object pallet. The partition of the third shelf 204c may be further adjusted dynamically (for example, removed or shifted) to accommodate a larger object pallet. In another embodiment, a height between two shelves of the MPUs 126 is adjustable to accommodate object pallets of different heights. The dynamically adjustable structure of the MPUs 126 increases storage efficiency of the MPUs 126 and allows the handling of object pallets having different physical characteristics. The COG of each of the MPUs 126 is pre-emptively maintained within the corresponding COG tolerance region by the control server 116, thus achieving required stability for transporting the MPUs 126.

FIGS. 3A and 3B are block diagrams that illustrate the MHE 108 of FIG. 1, in accordance with an exemplary embodiment of the disclosure. With reference to FIG. 3A, the MHE 108 includes a pair of prongs 302, a carriage 304 a movement mechanism 306, and an instruction device 308. It will be apparent that the MHE 108 may also include other suitable components or systems, in addition to the components or systems which are illustrated herein to describe and explain the function and operation of the present disclosure.

The pair of prongs 302 are extensions (for example, arms) that are attached to the carriage 304. The pair of prongs 302 is used to lift and carry an object pallet 310. Dimensions of the pair of prongs 302 may be dynamically adjustable based on the physical characteristics (for example, the weight, size, dimensions, or the like) of the object pallet 310. For example, a distance between the pair of prongs 302 is adjustable to accommodate object pallets of different sizes. The carriage 304 serves as a support structure to the pair of prongs 302. The movement mechanism 306 is used to move the carriage 304 along various directions (for example, X-axis, Y-axis, and Z-axis), thereby allowing the pair of prongs 302 to lift and place the object pallet 310 at a specified location.

In one embodiment, the MHE 108 may be operated manually by a human operator present in the storage facility 102. In another embodiment, the MHE 108 may operate automatically based on various instructions received by the instruction device 308 from the control server 116. The instruction device 308 may communicate with the control server 116 via the communication network 118 by using various wired, wireless, or optical communication protocols. The instruction device 308 may include suitable logic, instructions, circuitry, interfaces, and/or code, executable by the circuitry, to execute various operations for handling various object pallets 124a, 124b, 202a, 202b, 202c, and 310. In one example, the instruction device 308 may include a programmable logic circuitry (PLC) for performing corresponding operations under the control of the control server 116.

In one exemplary scenario, the instruction device 308 may receive an instruction from the control server 116. Based on the received instruction, the instruction device 308 may be configured to cause the MHE 108 to move and reach a location specified by the control server 116. The instruction device 308 may be further configured to instruct the movement mechanism 306 to control a movement of the carriage 304. Under the control of the instruction device 308, the movement mechanism 306 may move the carriage 304 for lifting the object pallet 310 from a first position by using the pair of prongs 302. In one example, the first position may be a pallet platform, for example, the first and second pallet platforms 128a and 128b. In another example, the first position may be a shelf of an MPU. The movement mechanism 306 may further move the carriage 304 for placing the lifted object pallet 310 at a second position by using the pair of prongs 302. In one example, the second position may be a shelf of an MPU. In another example, the second position may be a pallet platform, for example, the first and second pallet platforms 128a and 128b.

As shown in FIG. 3A, the MHE 108 has lifted the object pallet 310 using the pair of prongs 302. With reference to FIG. 3B, the MHE 108 has lifted the object pallet 310, and the movement mechanism 306 may cause the carriage 304 to move in a direction along the Y-axis. Thus, the carriage 304 moves along the Y-axis and causes the pair of prongs 302 to lift the object pallet 310.

FIGS. 4A to 4D are block diagrams that collectively illustrate an exemplary scenario 400 for storing an object pallet in an MPU, in accordance with an exemplary embodiment of the disclosure. With reference to FIG. 4A, the control server 116 may receive a first request for storing the object pallet 124a in the storage facility 102. In one example, the control server 116 may receive the first request when the details of the unique identifier that is assigned to the object pallet 124a are communicated to the control server 116. The control server 116 may store the unique identifier of the object pallet 124a in a memory of the control server 116. Based on the first request, the control server 116 may estimate the weight, the size, and the dimensions of the object pallet 124a. The control server 116 may select one of the PPP stations 110 for temporarily placing the object pallet 124a. The control server 116 may be configured to select one of the PPP stations 110 based on availability of the PPP stations 110, capacities of the pallet platforms of the PPP stations 110, throughputs of the PPP stations 110, or the like. For example, the control server 116 may determine that the first PPP station 110a is available (i.e., the first pallet platform 128a is vacant) for catering to the object pallet 124a. When the first PPP station 110a is determined to be available, the control server 116 may further determine whether the first pallet platform 128a is capable of handling the estimated weight, size, and dimensions of the object pallet 124a. In a scenario where the first pallet platform 128a is determined to be incapable of handling the estimated weight, size, and dimensions of the object pallet 124a, the control server 116 may identify another PPP station that is available. In a non-limiting example, it is assumed that the first pallet platform 128a is capable of handling the estimated weight, size, and dimensions of the object pallet 124a, and the control server 116 selects the first PPP station 110a for catering to the object pallet 124a. The object pallet 124a is then transferred to the automatic warehouse area 102b from the manual warehouse area 102a and placed on the first pallet platform 128a. As shown in FIG. 4A, the object pallet 124a is temporarily placed on the first pallet platform 128a.

The control server 116 may be further configured to identify one of the MPUs 126 for storing the object pallet 124a. The control server 116 may identify one of the MPUs 126 based on an availability of the MPUs 126 (for example, availability of empty shelves in the MPUs 126), a distance between the MPUs 126 and the first location of the first PPP station 110a, the weight of the object pallet 124a, load handling capacities of the MPUs 126, the COGs of the of the MPUs 126, or the like. In one exemplary scenario, the control server 116 may identify that that the first MPU 126a is available for storing the object pallet 124a and the distance between the current location of the first MPU 126a and the first location of the first PPP station 110a is minimum.

The control server 116 may further determine whether placing the object pallet 124a on the available shelf of the first MPU 126a maintains the COG of the first MPU 126a within the COG tolerance region of the first MPU 126a. For example, if the control server 116 determines that the placement of the object pallet 124a on the available shelf shifts the COG of the first MPU 126a out of the COG tolerance region, the control server 116 may identify another MPU 126 that is available. In a scenario where there are multiple available shelves in the identified first MPU 126a, the control server 116 may select one of the available shelves of the first MPU 126a based on various factors, for example, capacities of the shelves, the COG of the first MPU 126a, or the like. The control server 116 may further identify the first MPU 126a based on a cost for storing the object pallet 124a in the first MPU 126a. The cost for storing an object pallet in an MPU may be a cumulative factor that is a function of transportation time of the MPU, throughput, storage cost, transportation distance, or any other parameter that affects the efficiency and utilization of the storage facility 102. In another exemplary scenario, the control server 116 may further identify one of the MPUs 126 based on the material of the object pallet 124a. For example, object pallets stored in the first MPU 126a may include edible inventory items and object pallets stored in the second MPU 126b may include inventory items that are made of steel. In such a scenario, if the object pallet 124a includes fruits and vegetables, the control server 116 may identify that, from the first and second MPUs 126a and 126b that are available, the first MPU 126a is suitable for storing the object pallet 124a.

For achieving a correct placement of the object pallet 124a on the selected shelf of the first MPU 126a, the control server 116 may be configured to determine the features, for example, the edges of the selected shelf, the 3D envelope that represents a spatial region for the placement of the object pallet 124a, and/or an allowable overhang threshold for the object pallet 124a to extend beyond the first MPU 126a. The 3D envelope may correspond to a region of the selected shelf that is safe for placing the object pallet 124a. Thus, if the object pallet 124a is placed within the 3D envelope, the COG of the first MPU 126a is maintained within the corresponding COG tolerance region.

The control server 116 may further select at least one of the transport vehicles 106 for transporting the first MPU 126a. The control server 116 may select at least one of the transport vehicles 106 based on various selection factors, for example, availability of the transport vehicles 106, distances between current locations of the transport vehicles 106 and the current location of the first MPU 126a, the weight of the first MPU 126a, or the load handling capacities of the transport vehicles 106. For example, based on the real-time locations of the transport vehicles 106, the control server 116 may determine that of all the available transport vehicles 106, the first transport vehicle 106a is nearest to the first MPU 126a and capable of handling the weight of the first MPU 126a. Thus, the control server 116 may select the first transport vehicle 106a for transporting the first MPU 126a.

Based on the selection of the first transport vehicle 106a, the control server 116 may be configured to communicate a move instruction to the first transport vehicle 106a for instructing the first transport vehicle 106a to transport the first MPU 126a from the MPU storage area 104 to the first location of the first PPP station 110a. The move instruction may include navigation details of a path to be followed by the first transport vehicle 106a from the current location of the first transport vehicle 106a for transporting the first MPU 126a. For example, the move instruction may include details of the fiducial markers or localization coordinates that the first transport vehicle 106a may need to follow for traversing the required path. The move instruction may further include a source location (for example, the current location of the first transport vehicle 106a), an intermediate location (for example, the current location of the first MPU 126a), and a destination location (for example, the first location of the first PPP station 110a). The first transport vehicle 106a may include various sensors (such as image sensors, RFID sensors, GPS sensor, and/or the like) for recognizing and reading the fiducial markers or the localization coordinates. In FIG. 4A, the first transport vehicle 106a is shown to be transporting the first MPU 126a towards the first location of the first PPP station 110a.

With reference to FIG. 4B, the first transport vehicle 106a is shown to have reached at the first PPP station 110a. After reaching at the first PPP station 110a, the first transport vehicle 106a may place the first MPU 126a at the first location (for example, at the fiducial marker FM₆ of the first PPP station 110a. The first clamping unit 136a (as shown in FIG. 1) then tightly clamps the first MPU 126a to prevent any further movement of the first MPU 126a. In one embodiment, the first clamping unit 136a may include one or more sensors that may detect the presence of the first MPU 126a at the first location and initiate the clamping operation. The control server 116 may be further configured to communicate a placement instruction to the instruction device 308 of the MHE 108. The placement instruction may include details of the first location of the first PPP station 110a where the MHE 108 has to reach from the current location of the MHE 108. The placement instruction may include details of the selected shelf (as shown in FIG. 4C) of the first MPU 126a where the object pallet 124a is to be placed by the MHE 108 and the determined 3D envelope. Based on the placement instruction, the MHE 108 may lift the object pallet 124a from the first pallet platform 128a. As shown in FIG. 4B, the MHE 108 has lifted the object pallet 124a from the first pallet platform 128a using the pair of prongs 302 and the carriage 304 (as shown in FIG. 3A). After lifting the object pallet 124a, the MHE 108 moves towards the first MPU 126a for placing the lifted object pallet 124a.

With reference to FIG. 4C, a 3D view of the MHE 108 placing the object pallet 124a on the selected shelf (hereinafter, the selected shelf is referred to and designated as “the selected shelf 402”) of the first MPU 126a is shown. The first clamping unit 136a is shown to have clamped a leg of the first MPU 126a. In one embodiment, the first clamping unit 136a may clamp all legs of the first MPU 126a. In another embodiment, the first clamping unit 136a may clamp any number of legs of the first MPU 126a based on the weight of the first MPU 126a. In one exemplary scenario, if the first clamping unit 136a fails to clamp the leg/s of the first MPU 126a, the first tower light 134a may glow in red color and further operations may be put on halt until the fault in the clamping operation is resolved. In another scenario, if the first MPU 126a is successfully clamped by the first clamping unit 136a, the first tower light 134a may glow in green color and the MHE 108 may continue to operate.

The movement mechanism 306 may cause the carriage 304 to lift the object pallet 124a to a height of the selected shelf 402 for placing the object pallet 124a on the selected shelf 402. The instruction device 308 may verify the selected shelf 402 based on the bar code or QR code present on the selected shelf 402 of the first MPU 126a. The first alignment unit 132a may be configured to check the alignment of the MHE 108 and the lifted object pallet 124a with respect to the first MPU 126a. In one example, the object pallet 124a may be aligned with respect to the edges of the selected shelf 402 or the 3D envelope determined by the control server 116. A laser guiding technique or any other technique known in the art may be utilized to mark the shape of the 3D envelope on the selected shelf 402. In another example, the object pallet 124a may be misaligned with respect to the edges of the selected shelf 402 or the 3D envelope. If the object pallet 124a is misaligned, the first alignment unit 132a may correct the orientation of the object pallet 124a to align the object pallet 124a with respect to the edges of the selected shelf 402 or the 3D envelope. In another example, the MHE 108 may be aligned with respect to the first MPU 126a. In another example, the MHE 108 may be misaligned with respect to the first MPU 126a. If the MHE 108 is misaligned, the first alignment unit 132a may correct the orientation of the MHE 108 to align the MHE 108 with the first MPU 126a.

In one embodiment, the first MPU 126a may have empty pallets stored on the shelves of the first MPU 126a. In such a scenario, the control server 116 may further instruct the MHE 108 to remove the empty pallets from the shelves of the first MPU 126a. In one exemplary scenario, the empty pallet may be stored on the selected shelf 402 where the object pallet 124a is to be placed. In such a scenario, the MHE 108 may first remove the empty pallet from the selected shelf 402 and then store the object pallet 124a on the selected shelf 402 of the first MPU 126a.

In one embodiment, the control server 116 may determine that no MPU 126 has an available shelf for storing the object pallet 124a. However, the control server 116 may determine that the distance between two occupied shelves of the first MPU 126a may be large and may have enough empty space to accommodate a new shelf for storing an additional object pallet. In such a scenario, the control server 116 may further determine whether adding a new shelf between the two occupied shelves and placing the object pallet 124a on the new shelf is possible. If the control server 116 determines that the new shelf may be able to accommodate the object pallet 124a without shifting the COG of the first MPU 126a out of the COG tolerance region, the control server 116 may communicate a new instruction to the instruction device 308. The new instruction may cause the MHE 108 to add the new shelf in the first MPU 126a and then place the object pallet 124a on the newly added shelf. Thus, the shelves of the first MPU 126a are capable of dynamic adjustment to increase the storage capacity of the first MPU 126a.

With reference to FIG. 4D, the MHE 108 has placed the object pallet 124a on the selected shelf 402. The instruction device 308 may communicate a notification to the control server 116 indicating that the object pallet 124a is placed on the selected shelf 402. The control server 116 may be further configured to receive the second set of signals from the first transport vehicle 106a, the MHE 108, the first PPP station 110a, and/or the first MPU 126a based on the placement of the object pallet 124a on the selected shelf 402. The second set of signals may include digital images of the first MPU 126a. The digital images may indicate the orientation of the object pallet 124a that is placed on the selected shelf 402. The digital images may be captured by an imaging device included in at least one of: the first transport vehicle 106a, the MHE 108, and the first PPP station 110a. One of the second set of signals may indicate whether the object pallet 124a extends out of the first MPU 126a. For example, the edges of the shelves of the first MPU 126a may be equipped with one or more sensors (for example, infrared (IR) sensors) and the sensors may be configured to detect if object pallets placed on the shelves of the first MPU 126a extends out of the first MPU 126a. The sensors may be further configured to detect a distance by which the object pallets placed on the shelves of the first MPU 126a extends out of the first MPU 126a. One of the second set of signals received from the first transport vehicle 106a may indicate a weight distribution profile of the first MPU 126a. The second set of signals serves as a feedback to the control server 116 regarding the placement of the object pallet 124a on the selected shelf 402. In one embodiment, when the object pallet 124a is correctly placed on the selected shelf 402 of the first MPU 126a, the first tower light 134a may be configured to glow in green color indicating the correct placement of the object pallet 124a on the selected shelf 402.

Based on the received second set of signals, the control server 116 may be configured to determine whether the COG of the first MPU 126a is within the COG tolerance region of the first MPU 126a or the object pallet 124a is in alignment with respect to the determined features associated with the first MPU 126a (for example, the edges of the selected shelf 402, the 3D envelope, or the allowable overhang threshold). In one example, the control server 116 may utilize one or more image processing techniques on the received digital images to determine if the object pallet 124a is aligned with respect to the determined features associated with the first MPU 126a. If the control server 116 determines that the COG of the first MPU 126a is out of the COG tolerance region or the object pallet 124a is misaligned with respect to the determined features associated with the first MPU 126a, the control server 116 may communicate a rearrangement instruction to the instruction device 308 indicating to correct the alignment of the object pallet 124a.

The control server 116 may be further configured to communicate a move instruction to the first transport vehicle 106a to lift the first MPU 126a and transport the first MPU 126a from the first location to a second location in the MPU storage area 104. Based on the move instruction, the first transport vehicle 106a lifts the first MPU 126a and transports the first MPU 126a to the second location in the MPU storage area 104.

FIG. 5 is a block diagram that illustrates an exemplary scenario 500 for storing the object pallet 124a in the first MPU 126a, in accordance with another exemplary embodiment of the disclosure. The exemplary scenario 500 illustrates a 3D envelope 502 that is determined by the control server 116 for placing the object pallet 124a on the selected shelf 402.

In one embodiment, when the size of the object pallet 124a is smaller than or equal to the size of the selected shelf 402, the 3D envelope 502 determined by the control server 116 may be fully enclosed within the first MPU 126a. For example, when the selected shelf 402 and the object pallet 124a have a size of 1000 mm×1000 mm, the 3D envelope 502 may also have a size of 1000 mm×1000 mm that is fully enclosed within the first MPU 126a. In another embodiment (as shown in FIG. 5), when the size of the object pallet 124a is greater than the size of the selected shelf 402, the 3D envelope 502 determined by the control server 116 may extend beyond the selected shelf 402. For example, the selected shelf 402 may have a size of 1000 mm×1000 mm and the object pallet 124a may have a size of 1200 mm×1000 mm. In such a scenario, the 3D envelope 502 may extend 100 mm (i.e., overhang range) on both open sides of the selected shelf 402. In one embodiment, the control server 116 may further add the allowable overhang threshold to the dimensions of the 3D envelope 502. For example, when the allowable overhang threshold is 2 mm, the 3D envelope 502 may extend 102 mm on both open sides of the selected shelf 402.

With reference to FIG. 5, the control server 116 may determine that the object pallet 124a is not placed within the 3D envelope 502 by utilizing the received second set of signals. For example, the control server 116 may process the received digital images and the sensor signals to determine that a portion of the object pallet 124a is extending beyond the 3D envelope 502. In such a scenario, the first tower light 134a may glow in red color indicating that the object pallet 124a is misaligned with respect to the 3D envelope 502, and the control server 116 may communicate the rearrangement instruction to the instruction device 308 indicating the MHE 108 to correct the alignment of the object pallet 124a. In one embodiment, the rearrangement instruction may be displayed on a display screen of the instruction device 308 to indicate a human operator to correct the alignment of the object pallet 124a.

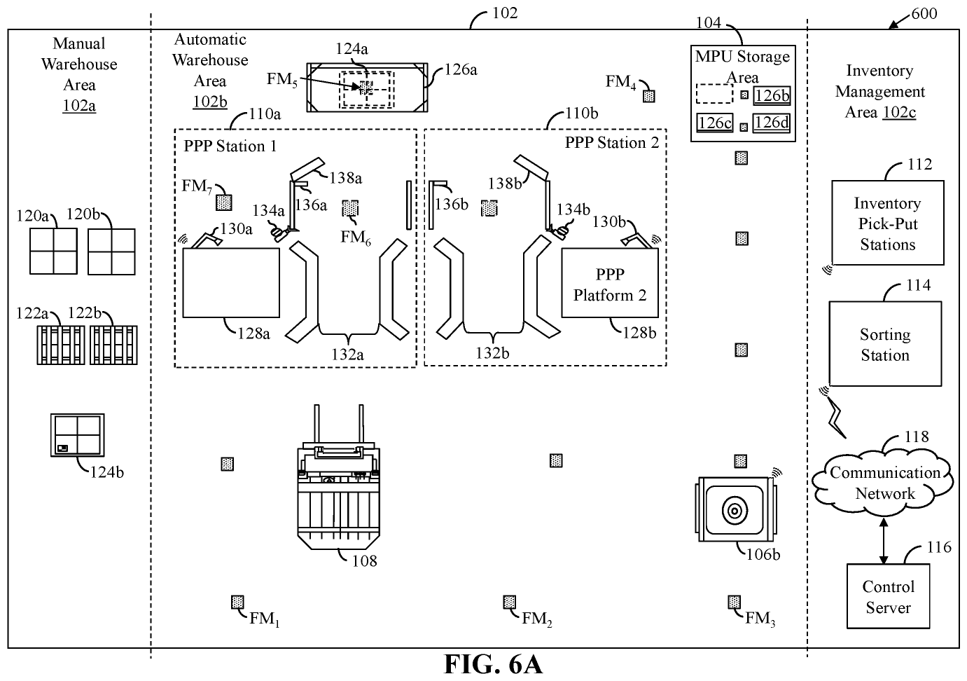

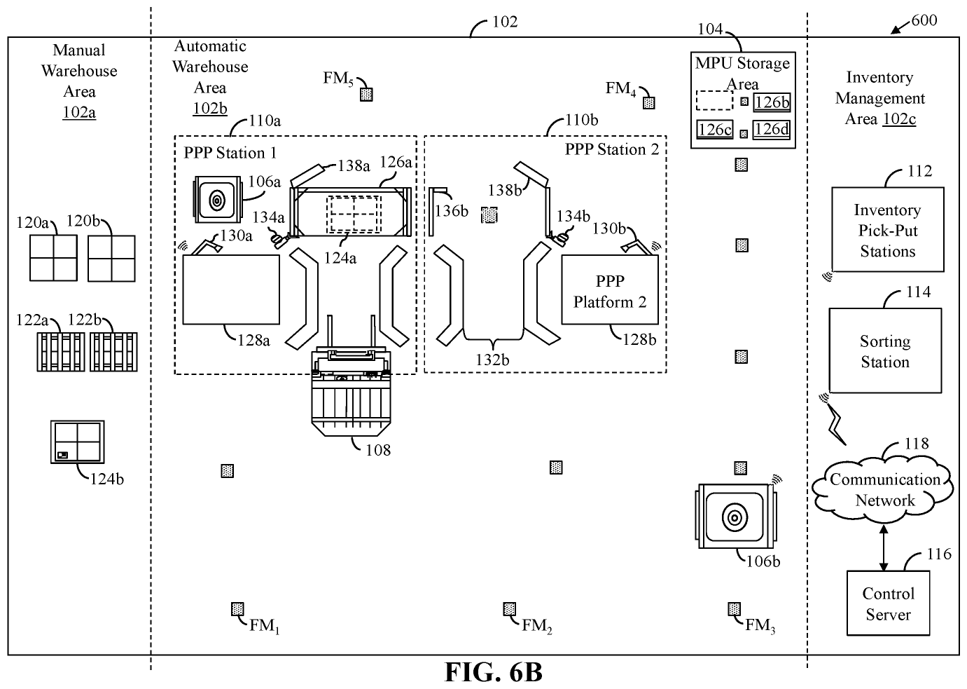

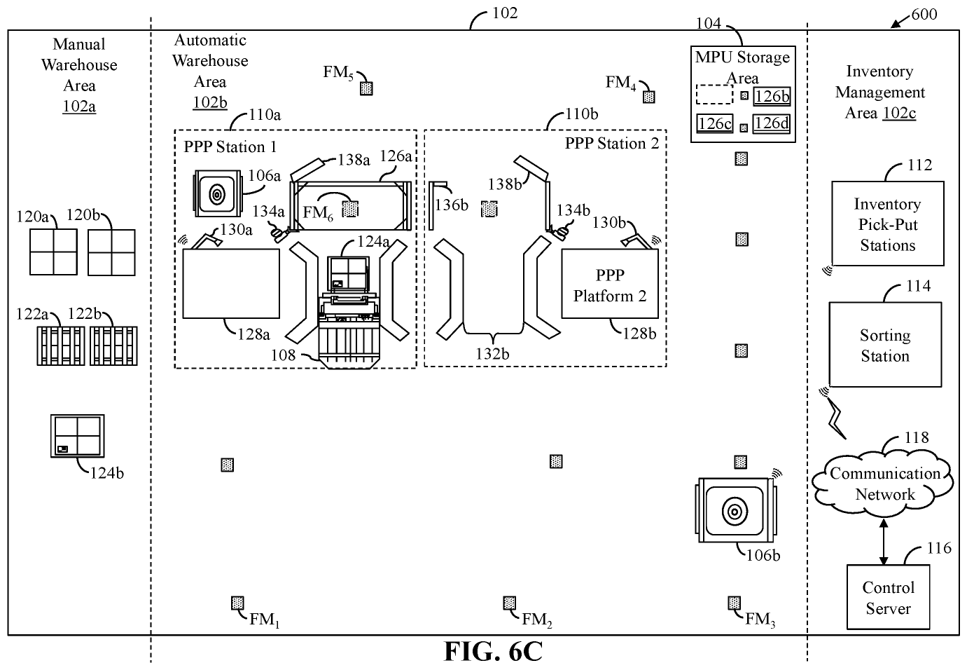

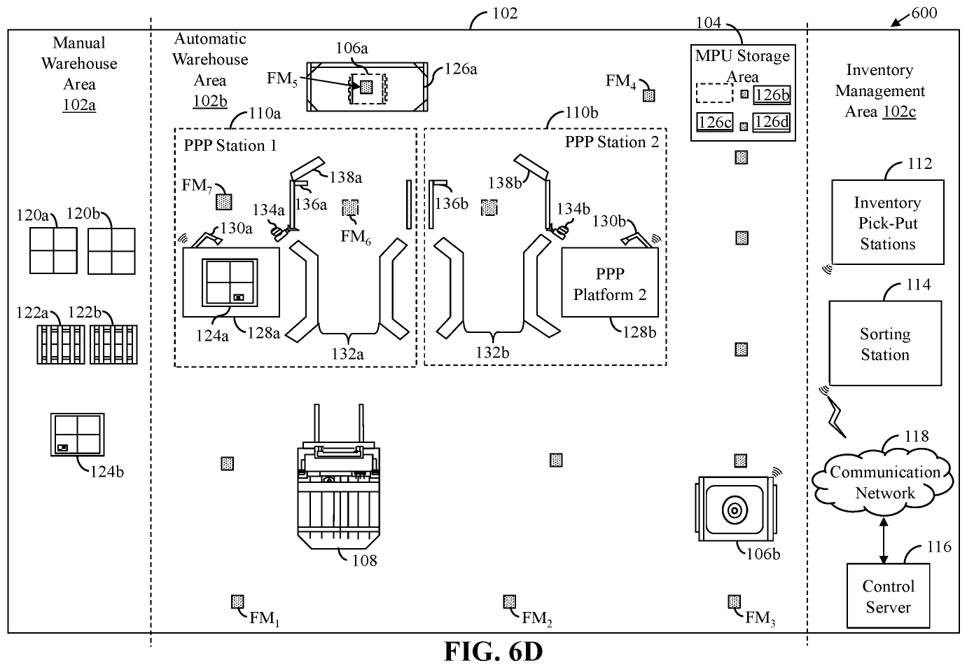

FIGS. 6A to 6D are block diagrams that collectively illustrate an exemplary scenario 600 for retrieving an object pallet from an MPU, in accordance with an exemplary embodiment of the disclosure.

With reference to FIG. 6A, the control server 116 may receive a second request for retrieving an object pallet (for example, the object pallet 124a) for fulfilling an order. Based on the second request, the control server 116 may identify one of the MPUs 126 that stores the object pallet 124a. For example, the control server 116 identifies the first MPU 126a stores the object pallet 124a. In a scenario where multiple MPUs store the required object pallet 124a, the control server 116 may identify one MPU for which the cost of retrieving the required object pallet 124a is minimum. The cost for retrieving an object pallet from an MPU may be a cumulative factor that is a function of transportation time of the MPU, throughput, transportation distance, or any other parameter that affects the efficiency and utilization of the storage facility 102. The control server 116 may further determine whether retrieving the object pallet 124a from the first MPU 126a maintains the COG of the first MPU 126a within the COG tolerance region of the first MPU 126a. For example, if the control server 116 determines that the retrieval of the object pallet 124a from the first MPU 126a may cause the COG of the first MPU 126a to shift out of the COG tolerance region, the control server 116 may identify another MPU 126 that may cater to the second request. In a non-limiting example, it is assumed that the control server 116 identifies the first MPU 126a for catering to the second request. In one embodiment, the control server 116 may select one of the PPP stations 110 for temporarily placing the object pallet 124a after retrieval. The selection of one of the PPP stations 110 has been described in the foregoing description of FIG. 4A. In another embodiment, when the object pallet 124a is required to be broken down for catering to the second request, the control server 116 may select one of the inventory pick-put stations 112 for breaking the object pallet 124a into individual inventory items. The selection of one of the inventory pick-put stations 112 is similar to the selection of the PPP stations 110 as described in the foregoing description of FIG. 4A. In a non-limiting example, it is assumed that the control server 116 selects the first PPP station 110a for catering to the object pallet 124a after retrieval.

The control server 116 may further select at least one of the transport vehicles 106 for transporting the first MPU 126a. The selection of at least one of the transport vehicles 106 has been described in the foregoing description of FIG. 4A. In a non-limiting example, the control server 116 selects the first transport vehicle 106a for transporting the first MPU 126a. Based on the selection of the first transport vehicle 106a, the control server 116 may be configured to communicate another move instruction to the first transport vehicle 106a for instructing the first transport vehicle 106a to transport the first MPU 126a from the MPU storage area 104 to the first location of the first PPP station 110a. The move instruction may include navigation details of a path to be followed by the first transport vehicle 106a from the current location of the first transport vehicle 106a for transporting the first MPU 126a. In FIG. 6A, the first transport vehicle 106a is shown to be transporting the first MPU 126a towards the first location of the first PPP station 110a.

With reference to FIG. 6B, the first transport vehicle 106a is shown to have reached at the first PPP station 110a. After reaching at the first PPP station 110a, the first transport vehicle 106a may place the first MPU 126a at the first location (for example, at the fiducial marker FM₆) of the first PPP station 110a. The first clamping unit 136a (as shown in FIG. 1) then tightly clamps the first MPU 126a to prevent any further movement of the first MPU 126a. The sensors of the first clamping unit 136a may detect the presence of the first MPU 126a at the first location and initiate the clamping operation.

The control server 116 may be further configured to communicate a retrieve instruction to the instruction device 308 of the MHE 108. The retrieve instruction may include details of the first location of the first PPP station 110a where the MHE 108 has to reach from the current location of the MHE 108. The retrieve instruction may further include details of the shelf of the first MPU 126a from where the object pallet 124a is to be retrieved by the MHE 108. Based on the retrieval instruction, the MHE 108 may lift the object pallet 124a from the shelf of the first MPU 126a.

With reference to FIG. 6C, the MHE 108 is shown to have reached the first location based on the retrieve instruction. The MHE 108 further lifts the object pallet 124a from the shelf of the first MPU 126a using the pair of prongs 302 and the carriage 304 (as shown in FIG. 3A). After lifting the object pallet 124a, the MHE 108 moves towards the first pallet platform 128a for placing the lifted object pallet 124a on the first pallet platform 128a.

With reference to FIG. 6D, the MHE 108 is shown to have placed the object pallet 124a on the first pallet platform 128a. The instruction device 308 may communicate a notification to the control server 116 indicating that the object pallet 124a is retrieved from the first MPU 126a and placed on the first pallet platform 128a. The control server 116 may be further configured to receive the second set of signals from at least one of: the first transport vehicle 106a, the MHE 108, the first PPP station 110a, and the first MPU 126a based on the retrieval of the object pallet 124a from the shelf of the first MPU 126a. The second set of signals may include digital images of the first MPU 126a. One of the second set of signals may indicate the weight distribution profile of the first MPU 126a after the retrieval of the object pallet 124a. The control server 116 may utilize the second set of signals to ensure that the COG of the first MPU 126a is within the COG tolerance region of the first MPU 126a after the retrieval of the object pallet 124a.

The control server 116 may be further configured to communicate a move instruction to the first transport vehicle 106a to lift the first MPU 126a and transport the first MPU 126a from the first location to a second location in the MPU storage area 104. Based on the move instruction, the first transport vehicle 106a lifts the first MPU 126a and transports the first MPU 126a to the second location in the MPU storage area 104.

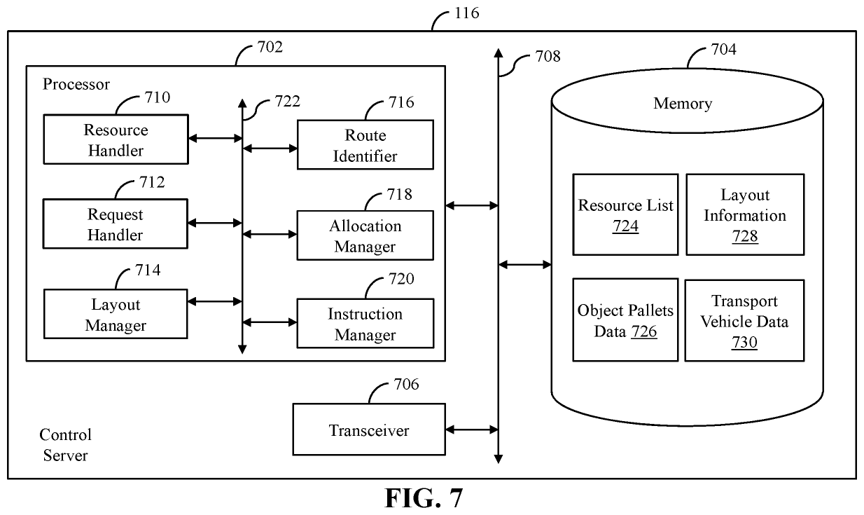

FIG. 7 is a block diagram that illustrates the control server 116, in accordance with an exemplary embodiment of the disclosure. The control server 116 includes a processor 702, a memory 704, and a transceiver 706 that communicate with each other by way of a first communication bus 708. The processor 702 includes a resource handler 710, a request handler 712, a layout manager 714, a route identifier 716, an allocation manager 718, and the instruction handler 720 that communicate with each other by way of a second communication bus 722. It will be apparent that the control server 116 is shown for illustrative purposes and not limited to any specific combination of hardware circuitry and software.

The processor 702 includes at least one of: suitable logic, instructions, circuitry, interfaces, and code, executable by the circuitry, for implementing various operations, for example, object pallet storage operations, order fulfillment operations, inventory management operations, or the like. In one embodiment, the processor 702 may be configured to facilitate the storage of various object pallets in the storage facility 102 and retrieval of the stored object pallets from the storage facility 102 (as described in FIGS. 1 to 6). Examples of the processor 702 may include, but are not limited to, at least one of: an application-specific integrated circuit (ASIC) processor, a reduced instruction set computing (RISC) processor, a complex instruction set computing (CISC) processor, a field-programmable gate array (FPGA), a combination of a central processing unit (CPU) and a graphics processing unit (GPU), a microcontroller, and the like.

The memory 704 includes at least one of: suitable logic, instructions, circuitry, interfaces, and code, executable by the circuitry, for storing resource list 724, object pallets data 726, layout information 728, and transport vehicle data 730. Examples of the memory 704 include a random-access memory (RANI), a read-only memory (ROM), a removable storage drive, a hard disk drive (HDD), a flash memory, a solid-state memory, and the like. In one embodiment, the memory 704 may be realized through various memory technologies such as, but not limited to, Microsoft® SQL, Oracle®, IBM DB2®, Microsoft Access®, PostgreSQL®, MySQL® and SQLite®. It will be apparent that the scope of the disclosure is not limited to realizing the memory 704 in the control server 116, as described herein. In other embodiments, the memory 704 may be realized in form of an external memory server or a cloud storage working in conjunction with the control server 116, without departing from the scope of the disclosure.

The resource list 724 includes information pertaining to the empty pallets (for example, the first and second empty pallets 122a and 122b) in the storage facility 102. For example, the resource list 724 may include the number of empty pallets 122 available in the storage facility 102, current locations of the empty pallets 122, and load handling capacity of each of the empty pallets 122. The resource list 724 may further include information of the MPUs 126, for example, number of MPUs 126, available shelves in the MPUs 126, the capacity of the MPUs 126, or the current COG of the MPUs 126.

The object pallets data 726 includes a list of the object pallets (for example, the object pallets 124a and 124b) received and stored at the storage facility 102. The object pallets data 726 further includes the unique identifiers assigned to the object pallets and the first set of parameters of the object pallets. The object pallets data 726 may further include details of inventory items included in each of the object pallets, type of the object pallets, locations of the object pallets in the storage facility 102, or the like.

The layout information 728 includes the virtual map of the storage facility 102. The virtual map may include information pertaining to the layout of the storage facility 102, such as the locations of the fiducial markers. The layout information 728 may further include real-time path availability information of various paths in the storage facility 102. For example, the layout information 728 may indicate that one or more paths in the storage facility 102 are closed down for maintenance.

The transport vehicle data 730 is indicative of the details of the transport vehicles 106 present in the storage facility 102. The details of each of the transport vehicles 106 may include a size, dimensions, a load carrying capacity, a maximum and minimum speed of the transport vehicle, or the like. The details may further include an identifier (such as a numeric or an alpha-numeric code) associated with the transport vehicles 106 and real-time information of the transport vehicles 106. The real-time information may include, for example, real-time locations of the transport vehicles 106, an availability status of the transport vehicles 106, or the like. The transport vehicle data 730 further includes real-time location and availability status of the MHE 108.

The transceiver 706 transmits and receives data over the communication network 118 using one or more communication network protocols. The transceiver 706 transmits various requests and information to the transport vehicles 106, the MHE 108, the PPP stations 110, the inventory pick-put stations 112, and the sorting station 114. The transceiver 706 receives various requests and messages from the transport vehicles 106, the MHE 108, the PPP stations 110, the inventory pick-put stations 112, and the sorting station 114. Examples of the transceiver 706 include, but are not limited to, an antenna, a radio frequency transceiver, a wireless transceiver, a Bluetooth transceiver, an ethernet based transceiver, a universal serial bus (USB) transceiver, or any other device configured to transmit and receive data.

The processor 702 performs various operations in the storage facility 102 by way of the resource handler 710, the request handler 712, the layout manager 714, the route identifier 716, the allocation manager 718, and the instruction handler 720. The resource handler 710 manages the resource list 724 stored in the memory 704. For example, the resource handler 710 may add information about new empty pallets available in the storage facility 102 to the resource list 724. The resource handler 710 may further update the information of the MPUs 126 when any object pallet is stored in the MPUs 126 or retrieved from the MPUs 126.

The request handler 712 processes all order requests received in the storage facility 102. For example, the request handler 712 processes the first request received in the storage facility 102. Based on the first request, the request handler 712 identifies the PPP station (for example, the first PPP station 110a) for temporarily placing the object pallets (for example, the object pallet 124a) on the pallet platform (for example, the first pallet platform 128a). The request handler 712 is further configured to merge various requests for optimizing operations at the storage facility 102. For example, if two requests (e.g., storage request and retrieval request) are received simultaneously in the storage facility 102 and the request handler 712 determines that both the requests may be processed simultaneously, the request handler 712 may merge both the requests to improve efficiency and throughput at the storage facility 102. In one embodiment, when all the MPUs 126 are occupied, the request handler 712 may queue the request for a specific-time interval until an appropriate MPU becomes available for storage.

The layout manager 714 manages the layout information 728. For example, if there is any change in the layout of the storage facility 102 (such as a change in the arrangement of the MPUs 126), the layout manager 714 updates the layout information 728 based on the change in the layout. The route identifier 716 is responsible for determining the paths for the transport vehicles 106 and the MHE 108 to transit in the storage facility 102. In one embodiment, if at least one of: the transport vehicles 106 and the MHE 108 encounter real-time obstacles while transiting, the route identifier 716 determines alternate routes for at least one of: the transport vehicles 106 and the MHE 108.

The allocation manager 718 handles the allocation of the transport vehicles 106 for transporting the MPUs 126 based on the received requests. For example (as described in FIGS. 4A to 4D), the allocation manager 718 selects the first transport vehicle 106a that is available for transporting the first MPU 126a from the MPU storage area 104 to the first location of the first PPP station 110a.

The instruction handler 720 is responsible for communicating various instructions to the transport vehicles 106 and the MHE 108. The instruction handler 720 may communicate the move instruction to the transport vehicles 106 for transporting the MPUs 126 from one location to another. For example, the instruction handler 720 may communicate the move instruction to the first transport vehicle 106a for transporting the first MPU 126a from the MPU storage area 104 to the first location of the first PPP station 110a. The instruction handler 720 may be configured to communicate the placement, retrieve, and/or rearrangement instructions to the MHE 108.

Although, the processor 702 is depicted as a hardware component in FIG. 7, it will be appreciated that the scope of the disclosure is not limited to realizing the processor 702 as the hardware component. In another embodiment, the functionality of the processor 702 may be implemented by way of a computer executable code or a set of computer readable instructions stored in the memory 704, without deviating from the spirit of the disclosure.

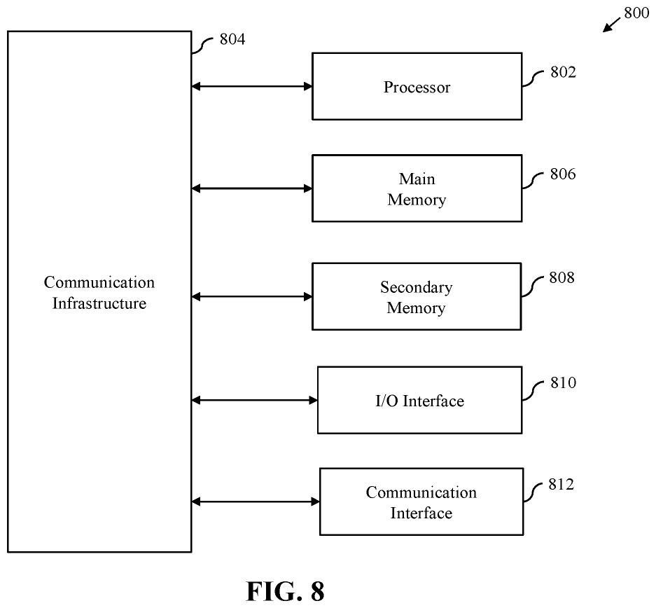

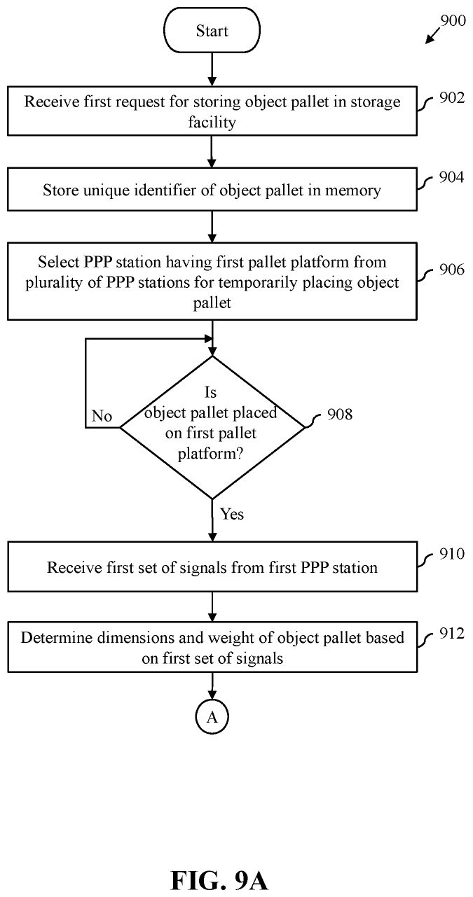

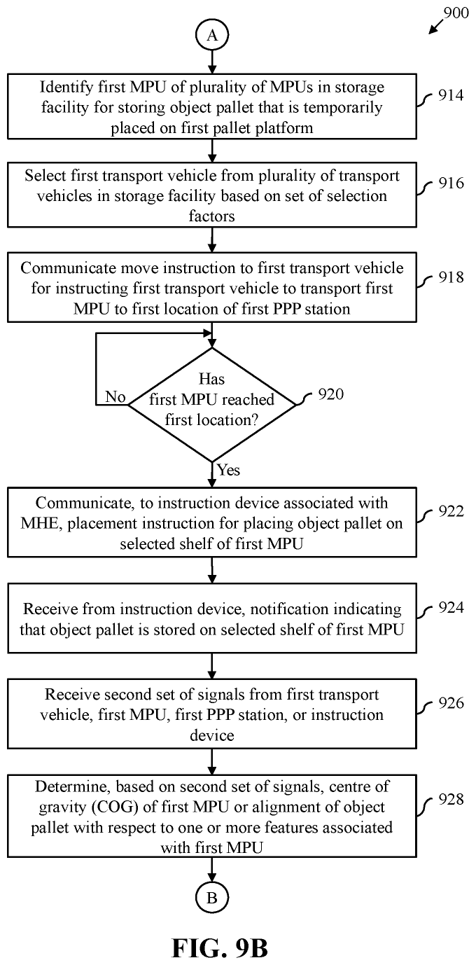

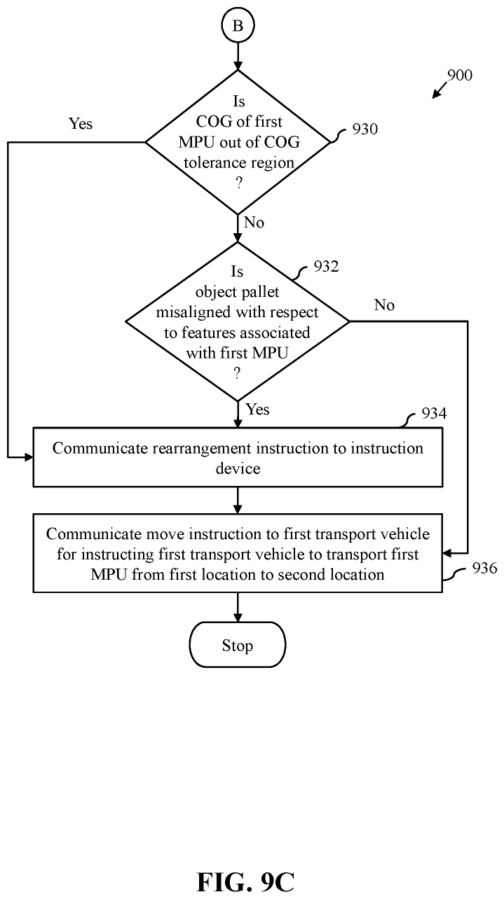

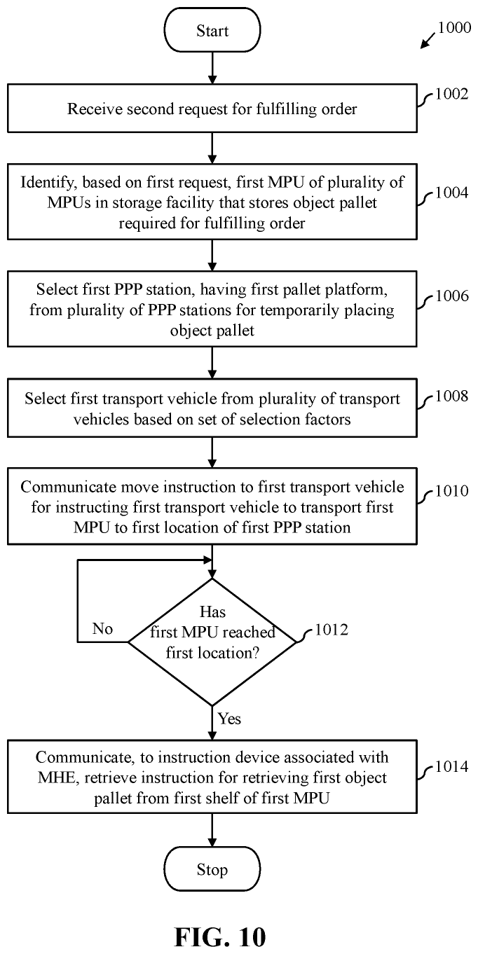

FIG. 8 is a block diagram that illustrates system architecture of a computer system 800, in accordance with an exemplary embodiment of the disclosure. An embodiment of disclosure, or portions thereof, may be implemented as computer readable code on the computer system 800. In one example, the transport vehicles 106, the MHE 108, the PPP stations 110, the inventory pick-put stations 112, the sorting station 114, and the control server 116 may be implemented in the computer system 800. Hardware, software, or any combination thereof may embody modules and components used to implement methods of FIGS. 9A to 9C and 10. The computer system 800 includes a processor 802 that may be connected to a communication infrastructure 804. The computer system 800 may further include a main memory 806 and a secondary memory 808. The computer system 800 further includes an input/output (I/O) interface 810 and a communication interface 812. The communication interface 812 may allow data transfer between the computer system 800 and various devices that are communicatively coupled to the computer system 800.

FIGS. 9A to 9C, collectively, represent a flow chart 900 that illustrates a process (e.g., method) for storing an object pallet in an MPU, in accordance with an exemplary embodiment of the disclosure. The process may generally start at a step 902, where the control server 116 receives the first request for storing the object pallet 124a in the storage facility 102. The control server 116 further receives the details pertaining to the unique identifier assigned to the object pallet 124a by way of the first request. The process proceeds to a step 904, where the control server 116 stores the received unique identifier of the object pallet 124a in the memory 704 of the control server 116. The process proceeds to a step 906, where the control server 116 selects the first PPP station 110a, having the first pallet platform 128a, from the PPP stations 110 for temporarily placing the object pallet 124a.

The process proceeds to a step 908, where the control server 116 determines whether the object pallet 124a is placed on the first pallet platform 128a of the first PPP station 110a. If at the step 908, it is determined that the object pallet 124a is not placed on the first pallet platform 128a, the process remains on the step 908. If at the step 908, it is determined that the object pallet 124a is placed on the first pallet platform 128a, the process proceeds to a step 910. At the step 910, the control server 116 receives the first set of signals from the first PPP station 110a. The process proceeds to a step 912, where the control server 116 determines, based on the received first set of signals, the weight, size, shape, and dimensions of the object pallet 124a. The process proceeds to process A.

With reference to FIG. 9B, the process A proceeds to a step 914, where the control server 116 identifies the first MPU 126a from the MPUs 126 for storing the object pallet 124a that is temporarily placed on the first pallet platform 128a. The process proceeds to a step 916, where the control server 116 selects the first transport vehicle 106a from the transport vehicles 106 based on the selection factors. The selection factors include the availability of the first transport vehicle 106a, the distance between the first transport vehicle 106a and the first MPU 126a, the weight of the first MPU 126a, the load handling capacity of the first transport vehicle 106a, or the like. The process proceeds to a step 918, where the control server 116 communicates the move instruction to the first transport vehicle 106a for instructing the first transport vehicle 106a to transport the first MPU 126a from the MPU storage area 104 to the first location of the first PPP station 110a. The process proceeds to a step 920, where the control server 116 determines whether the first MPU 126a has reached the first location of the first PPP station 110a. If at the step 920, it is determined that the first MPU 126a has not reached the first location of the first PPP station 110a, the process remains on the step 920. If at the step 920, it is determined that the first MPU 126a has reached the first location of the first PPP station 110a, the process proceeds to a step 922. At the step 922, the control server 116 communicates the placement instruction to the instruction device 308 of the MHE 108 for placing the object pallet 124a on the selected shelf 402 (as shown in FIG. 4C) of the first MPU 126a. The process proceeds to a step 924, where the control server 116 receives the notification from the instruction device 308 indicating that the object pallet 124a is placed on the selected shelf 402 of the first MPU 126a. The process proceeds to a step 926, where the control server 116 receives the second set of signals from at least one of: the first transport vehicle 106a, the first MPU 126a, the first PPP station 110a, and the instruction device 308. The process proceeds to a step 928, where the control server 116 determines the COG of the first MPU 126a or the alignment of the object pallet 124a with respect to the features associated with the first MPU 126a (for example, the 3D envelope 502 or the edges of the selected shelf 402) based on the second set of signals. The process proceeds to process B.

With reference to FIG. 9C, the process B proceeds to a step 930, where the control server 116 determines whether the COG of the first MPU 126a is out of the COG tolerance region. If at the step 930, it is determined that the COG of the first MPU 126a is within the COG tolerance region, the process proceeds to a step 932. At the step 932, the control server 116 determines whether the object pallet 124a is misaligned with respect to the determined features associated with the first MPU 126a. If at the step 932, it is determined that the object pallet 124a is misaligned, the process proceeds to a step 934. If at the step 930, it is determined that the COG of the first MPU 126a is out of the COG tolerance region, the process proceeds to the step 934. At the step 934, the control server 116 communicates the rearrangement instruction to the instruction device 308. If at the step 932, it is determined that the object pallet 124a is in alignment with respect to the determined features associated with the first MPU 126a, the process proceeds to a step 936. At the step 936, the control server 116 communicates the move instruction to the first transport vehicle 106a to transport the first MPU 126a from the first location to the second location in the MPU storage area 104. After the step 936, the process stops.

FIG. 10 represents a flow chart 1000 that illustrates a process (e.g., method) for retrieving object pallets from the MPUs 126, in accordance with an exemplary embodiment of the disclosure. The process may generally start at a step 1002, where the control server 116 receives the second request for fulfilling the order. The process proceeds to a step 1004, where the control server 116 identifies the first MPU 126a from the MPUs 126, based on the first request, which stores the object pallet 124a required for fulfilling the order. The process proceeds to a step 1006, where the control server 116 selects the first PPP station 110a from the PPP stations 110 for temporarily placing the object pallet 124a after retrieval. The process proceeds to a step 1008, where the control server 116 selects the first transport vehicle 106a from the transport vehicles 106 based on the selection factors. The selection factors include the availability of the first transport vehicle 106a, the distance between the first transport vehicle 106a and the first MPU 126a, the weight of the first MPU 126a, or the load handling capacity of the first transport vehicle 106a. The process proceeds to a step 1010, where the control server 116 communicates the move instruction to the first transport vehicle 106a for instructing the first transport vehicle 106a to transport the first MPU 126a from the MPU storage area 104 to the first location of the first PPP station 110a. The process proceeds to a step 1012, where the control server 116 determines whether the first MPU 126a has reached the first location. If at the step 1012, it is determined that the first MPU 126a has not reached the first location, the process remains on the step 1012. If at the step 1012, it is determined that the first MPU 126a has reached the first location, the process proceeds to a step 1014. At the step 1014, the control server 116 communicates the retrieve instruction to the instruction device 308 of the MHE 108 for retrieving the object pallet 124a from the selected shelf 402 of the first MPU 126a and placing the object pallet 124a on the first pallet platform 128a. After the step 1014, the process stops.

Technical improvements in the system components (for example, the transport vehicles 106, the MHE 108, the PPP station 110, the control server 116, and the MPUs 126) of the storage facility 102 has led to an increase in the efficiency and throughput of the storage facility 102. As the MPUs 126 are capable of storing multiple object pallets 124, the storage capacity of the storage facility 102 is increased. Since an automated environment is operated under the control server 116, human intervention is decreased and hence, the throughput of the operations at the storage facility 102 increases. Furthermore, simultaneous operations can be performed on the MPUs 126 in a single transit operation. For example, when the first MPU 126a reaches the first location, placement and retrieval of the object pallets 124 may take place simultaneously. Technological improvements in the system components of the storage facility 102 enables the implementation of the GTP environment in the storage facility 102 in a more efficient, cost effective, easy to install, time efficient, and secure manner.

A person of ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Techniques consistent with the present disclosure provide, among other features, systems and methods for handling object pallets in the storage facility. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A system for handling a plurality of object pallets in a storage facility, the system comprising:
a plurality of pallet pick-put (PPP) stations having a plurality of pallet platforms, respectively;
a plurality of movable pallet units (MPUs) located in the storage facility, wherein each MPU of the plurality of MPUs is a multi-level pallet unit;
a material handling equipment (MHE) that is configured to lift the plurality of object pallets from the plurality of pallet platforms for storing in the plurality of MPUs; and
a control server that is communicatively coupled to the plurality of PPP stations and the MHE, wherein the control server is configured to:
receive a first request for storing a first object pallet in the storage facility,
select a first PPP station, having a first pallet platform, from the plurality of PPP stations for temporarily placing the first object pallet,
identify a first MPU of the plurality of MPUs to store the first object pallet that is temporarily placed on the first pallet platform, and
communicate, to an instruction device associated with the MHE, a placement instruction for placing the first object pallet on a first shelf of the first MPU, wherein based on the placement instruction, the first object pallet is lifted from the first pallet platform and placed on the first shelf of the first MPU by the MHE when the first MPU reaches at a first location of the first PPP station.

2. A system of claim 1, wherein the control server is further configured to receive from the instruction device, a notification indicating that the first object pallet is stored on the first shelf of the first MPU.

3. A system of claim 1, further comprising a plurality of transport vehicles stationed at the storage facility, wherein the plurality of transport vehicles transport the plurality of MPUs to a plurality of locations associated with the plurality of PPP stations.

4. A system of claim 3, wherein the control server is further configured to:
select a first transport vehicle from the plurality of transport vehicles based on a set of selection factors, wherein the set of selection factors includes at least one of an availability of the first transport vehicle, a distance between the first transport vehicle and the first MPU, a weight of the first MPU, or a capacity of the first transport vehicle, and
communicate a move instruction to the first transport vehicle for instructing the first transport vehicle to transport the first MPU to the first location of the first PPP station.

5. A system of claim 4, wherein the control server is further configured to:
receive a first set of signals from at least one of the first transport vehicle, the first MPU, the first PPP station, or the instruction device when the first object pallet is stored on the first shelf of the first MPU,
determine, based on the first set of signals, at least one of a center of gravity (COG) of the first MPU or an alignment of the first object pallet with respect to one or more features associated with the first MPU, and
communicate, to the instruction device, a rearrangement instruction when the first object pallet is determined to be misaligned with respect to the one or more features or when the COG of the first MPU is determined to be out of a COG tolerance region of the first MPU.

6. A system of claim 1, wherein the control server is further configured to:
receive a second request for fulfilling an order,
identify based on the second request, a second MPU of the plurality of MPUs that stores a second object pallet required for fulfilling the order,
select a second PPP station, having a second pallet platform, from the plurality of PPP stations for temporarily placing the second object pallet, and
communicate, to the instruction device, a retrieve instruction for retrieving the second object pallet from a second shelf of the second MPU, wherein based on the retrieve instruction, the second object pallet is lifted from the second shelf and placed on the second pallet platform by the MHE when the second MPU reaches at a second location of the second PPP station.

7. A system of claim 1, wherein the control server is further configured to:
receive a first set of signals from the first PPP station when the first object pallet is placed on the first pallet platform, and
determine a first set of dimensions and a weight of the first object pallet based on the first set of signals.

8. A system of claim 1, wherein the control server is further configured to select the first PPP station based on at least one of an availability of the first PPP station, a capacity of the first pallet platform, or a throughput of the first PPP station.

9. A system of claim 1, wherein the control server is further configured to identify the first MPU based on at least one of an availability of the first MPU, a distance between the first MPU and the first location of the first PPP station, a weight of the first object pallet, or a weight handling capacity of the first MPU.

10. A system of claim 1, wherein the first MPU has a dynamic structure, such that a plurality of shelves, including the first shelf, in the first MPU are dynamically adjustable to accommodate the first object pallet.

11. A method for handling a plurality of object pallets in a storage facility, the method comprising:
receiving, by a control server, a first request for storing a first object pallet in the storage facility;
selecting, by the control server, a first PPP station, having a first pallet platform, from a plurality of pallet pick-put (PPP) stations for temporarily placing the first object pallet;
identifying, by the control server, a first movable pallet unit (MPU) of a plurality of MPUs in the storage facility for storing the first object pallet that is temporarily placed on the first pallet platform, wherein each MPU of the plurality of MPUs is a multi-level pallet unit; and
communicating, by the control server to an instruction device associated with a material handling equipment (MHE), a placement instruction for placing the first object pallet on a first shelf of the first MPU, wherein based on the placement instruction, the first object pallet is lifted from the first pallet platform and placed on the first shelf of the first MPU by the MHE when the first MPU reaches at a first location of the first PPP station.

12. A method of claim 11, further comprising receiving, by the control server from the instruction device, a notification indicating that the first object pallet is stored on the first shelf of the first MPU.

13. A method of claim 11, further comprising:
selecting, by the control server, a first transport vehicle from a plurality of transport vehicles in the storage facility based on a set of selection factors, wherein the set of selection factors includes at least one of an availability of the first transport vehicle, a distance between the first transport vehicle and the first MPU, a weight of the first MPU, or a capacity of the first transport vehicle; and
communicating, by the control server, a move instruction to the first transport vehicle for instructing the first transport vehicle to transport the first MPU to the first location of the first PPP station.

14. A method of claim 13, further comprising:
receiving, by the control server, a first set of signals from at least one of the first transport vehicle, the first MPU, the first PPP station, or the instruction device when the first object pallet is stored on the first shelf of the first MPU;
determining, by the control server, based on the first set of signals, at least one of a center of gravity (COG) of the first MPU or an alignment of the first object pallet with respect to one or more features associated with the first MPU; and
communicating, by the control server to the instruction device, a rearrangement instruction when the first object pallet is determined to be misaligned with respect to the one or more features or when the COG of the first MPU is determined to be out of a COG tolerance region of the first MPU.

15. A method of claim 11, further comprising:
receiving, by the control server, a first set of signals from the first PPP station when the first object pallet is placed on the first pallet platform; and
determining, by the control server, a first set of dimensions and a weight of the first object pallet based on the first set of signals.

16. A method of claim 11, further comprising selecting, by the control server, the first PPP station based on at least one of an availability of the first PPP station, a capacity of the first pallet platform, or a throughput of the first PPP station.

17. A method of claim 11, further comprising identifying, by the control server, the first MPU based on at least one of an availability of the first MPU, a distance between the first MPU and the first location of the first PPP station, a weight of the first object pallet, or a weight handling capacity of the first MPU.

18. A method of claim 11, wherein the first MPU has a dynamic structure, such that a plurality of shelves, including the first shelf, in the first MPU are dynamically adjustable to accommodate the first object pallet.

19. A method for handling a plurality of object pallets in a storage facility, the method comprising:
receiving, by a control server, a first request for fulfilling an order;
identifying, by the control server, based on the first request, a first MPU of a plurality of MPUs in the storage facility that stores a first object pallet required for fulfilling the order, wherein each MPU of the plurality of MPUs is a multi-level pallet unit;
selecting, by the control server, a first PPP station, having a first pallet platform, from a plurality of pallet pick-put (PPP) stations for temporarily placing the first object pallet; and
communicating, to an instruction device associated with a material handling equipment (MHE), a retrieve instruction for retrieving the first object pallet from a first shelf of the first MPU, wherein based on the retrieve instruction, the first object pallet is lifted from the first shelf and placed on the first pallet platform by the MHE when the first MPU reaches at a first location of the first PPP station.

20. A method of claim 19, further comprising:
selecting, by the control server, a first transport vehicle from a plurality of transport vehicles based on a set of selection factors, wherein the set of selection factors includes at least one of an availability of the first transport vehicle, a distance between the first transport vehicle and the first MPU, a weight of the first MPU, or a capacity of the first transport vehicle; and
communicating, by the control server, a move instruction to the first transport vehicle for instructing the first transport vehicle to transport the first MPU to the first location of the first PPP station.
